(19) United States
(12) Patent Application Publication
(10) Pub. No.: US 2003/0145338 A1
(43) Pub. Date: Jul. 31, 2003

(54) System and process for incorporating, retrieving and displaying an enhanced flash movie

(75) Inventor: Jeffrey M. Harrington, Brooklyn, NY (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: ACTV, Inc., New York, NY

(21) Appl. No.: 10/354,705

(22) Filed: Jan. 29, 2003

Related U.S. Application Data
(60) Provisional application No. 60/353,510, filed on Jan. 31, 2002.

(51) Int. Cl. H04N 7/173; H04N 7/16; H04N 7/00; H04N 11/00

(52) U.S. Cl. 725/136; 725/112; 725/113; 725/86; 725/109; 348/461

(57) ABSTRACT

A system and process for incorporating, retrieving and displaying an Enhanced Flash Movie (EFM) is provided. One embodiment of the system utilizes an URI decoder to extract from a combined signal an address identifying a provider of an EFM. The EFM may provide a Flash Movie, a Movie Player and at least one trigger, wherein the trigger provides a mean value pair data structure having a variable segment and a value segment. The trigger identifies when and from whom Enhanced Content related to the Flash Movie is available for presentation to the client via a client device with a Flash enabled Web browser. In another embodiment, a direct connection between a client device and a provider of an EFM is utilized to obtain the EFM. The EFM and/or the Enhanced Content related to a Flash Movie provided with the EFM may also be obtained directly from a computer readable medium.

### CROSS REFERENCE TO RELATED APPLICATION

The present application claims priority to and incorporates by reference, in its entirety, U.S. Provisional Patent application serial No. 60/353,510, which is entitled “Technique Incorporating and Displaying Retrieved Integrated Internet Information Segments in Video and Audio Encoded as Flash Files” and was filed on Jan. 31, 2002 in the name of inventor Jeffrey Michael Harrington.

### TECHNICAL FIELD

The technical field relates generally to the presentation of a Flash™ movie on a user's device. More specifically, the technical field relates to the synchronizing of programming in a Flash™ movie with enhanced content based upon the insertion of triggers into the Flash™ movie.

Reference to a Computer Program Listing

One compact disc containing a computer program listing appendix in one file entitled “Appendix A.txt” created Jan. 24, 2003 (6 KB) format a part of this application and is herein incorporated by reference.

### BACKGROUND

Today, the capabilities of computers to provide massive amounts of educational and entertainment information has exploded with the Internet. The Internet has the power to transform society through unprecedented levels of information flow between members. Currently, on-line systems offer a variety of different services to users, including news feeds, electronic databases (either searchable by the user directly on the on-line system, or downloadable to the user's own computer), private message services, electronic newsletters, real-time games for play by several users at the same time, and job placement services, to name a few. However, today, most on-line communications occur merely through text. This currently stands in great contrast to the audio/visual presentation of the alternative electronic medium, television. However, it is expected that as multi-media's incessant growth continues, audio/visual programs will proliferate and text will become less and less dominant in the on-line environment. Even though these programs will be introduced, the Internet will remain essentially user unfriendly due to its very massiveness, organization and randomness. Simply stated, there is no order or direction in the Internet. Specific pieces of information are many times hard to find, and harder yet, is the ability to put these pieces of information into a meaningful context.

Television, on the other hand, has been criticized for being a passive medium—“chewing gum for the eyes,” as Fred Allen once observed. Television has always been something you watched, not something you do. Many social critics believe that the passivity television depends on has seeped into our culture, turning a nation of citizens into a nation of viewers. While interactive television systems have increased the level of user interaction, and thus, provided greater learning and entertainment opportunities, vast information resources such as databases are inaccessible from such a medium.

Recent innovations in combining Internet content with television and other audio and/or video programming signals have been described in various patents and publications, for example, U.S. Pat. No. 5,778,181, which issued on Jul. 7, 1998 to Jack D. Hidary, et al., and also in U.S. Pat. No. 5,774,664, which issued on Jun. 30, 1998 to Jack D. Hidary, et al., (hereinafter, collectively the “Hidary patents”), and also U.S. Pat. No. 6,018,768, which issued on Jan. 25, 2000 to Craig Ullman, et al., the contents of all of which are herein incorporated by reference in their entirety. As is now well known in the art, these patents describe innovative systems and processes for combining the user friendly visual experience of television programming signals, and other time based events or signals, with information resources located on the Internet which relate to the programming signal (hereinafter, the “Enhanced Content”). Since segments in a programming signal are generally presented in a sequence to a client based upon a reference to a starting point or a known event (for example, the amount of time remaining in a football game is based upon the kick-off, or the amount of time remaining in a recorded movie is based upon when the playback of the movie is started and not when it was actually recorded), such programming signals shall herein be regarded as applying to any signal, show, or sequence of events, whether pre-recorded or live, which are defined or based upon a temporal relationship (hereinafter, the “Temporal Signal”). Such Temporal Signals may include live events (for example, a cut-away by a television broadcaster to a then breaking news event), pre-recorded events, and combinations of live and pre-recorded events.

Recently, various approaches have been implemented for providing client-side and server-side systems capable of providing Enhanced Content related to a Temporal Signal. Such approaches generally require a client to download (commonly from an Internet based Web site) and then install a proprietary plug-in or software, which configures the client's system as a specific application. Another approach utilizes a client system's Web browser, and a downloaded program which configures the client system to retrieve Enhanced Content over a specific type of communications link, for a specific type of client device, based upon the reception of a Temporal Signal and an address identifying a provider of Enhanced Content related thereto. Regardless of the specific methodology, today's client systems commonly must execute a download to receive and present Enhanced Content program segments which relate to a given Temporal Signal.

Further, since the Internet has innumerable sites, which a client may or may not find using a search engine, producers of Temporal Signals often identify a location providing Enhanced Content (for example, an Internet site) by presenting a Uniform Resource Identifier (“URI”), which include Uniform Resource Locators (“URLs”), or similar addresses in the video or audio signal presenting the Temporal Signal. Once the site is identified by the client and/or the client's system, the approach then commonly requires the client system to register the client with the provider of the Enhanced Content. Such registration may be utilized, for example, to record client interests, viewing behavior and the like.

Following registration, the client then may actually need to select a program or segment for which the client desires to receive the Enhanced Content. Once selected, the client side system then often downloads and installs a Java applet, or similar program code, which configures the client device for receiving the specific Enhanced Content. At this point, the client system is then ready to connect to the provider of the Enhanced Content, satisfy any pre-requisites (for example, providing a password, sign-on, or user profile information), and receive the Enhanced Content.

As such, the approaches commonly utilized today to receive Enhanced Content generally require a client to first identify a location of a provider of Enhanced Content, register the client with the provider, download a program which configures the client system, install the program, connect to a site providing Enhanced Content related to a specific Temporal Signal, and then satisfy any pre-requisites prior to receiving the Enhanced Content (for example, providing user profile information). In short, these approaches often require so much time and effort to configure the client side system and access the Enhanced Content that many clients are discouraged from utilizing such systems.

Further, as the Internet has matured, new methodologies and systems for presenting Temporal Signals via an Internet connection, instead of a broadcast, cable or satellite connection, have come to fruition. Generally, these system utilize the Hyper-Text Transport Protocol (HTTP) and the Hyper Text Markup Language (HTML) to transmit video and audio programming signals to Web browsers (e.g., Microsoft's® Internet Explorer® and AOL's® Netscape®). However, such HTTP based programming signals often require specific application software to be loaded onto the user's device in order to present a video program. Examples of such application software include Real Network's® RealPlayer®, Microsoft's® Media Player® and Apple Computer's® Quicktime®. As is commonly appreciated, such software applications generally are not compatible with each other, and often are not freely provided. As such, users are often required to purchase and install at least one of the Real Player®, Media Player®, and Quicktime® software applications in order to receive a given Temporal Signal. Similarly, in order to ensure the widest possible market can receive a program, producers are often forced to produce a given Temporal Signal in each of the Real Player®, Media Player®, and Quicktime® formats.

Recently, another option, Macromedia® Flash™ alone, in combination with Wildform's™ Flix™ (see www.wildform.com/flix) application, and/or in combination with other audio video compiler software applications have become available for encoding audio and video programs (i.e., Temporal Signals) in Flash™ and playing Flash files on a user device using a Flash player™. Further, Flash™ software commonly includes the functionality to compile audio and video files directly into the Flash™ format. Since this option utilizes Flash™, which is estimated to be currently installed on over 96% of all Web compatible computers, this option is compatible with practically all of the currently available Web browsers and does not require the user to download specific application software in order to play the Flash™ encoded audio and/or video program. As is well known in the art, Macromedia® Flash™ technology includes a powerful animation application, which may substantially replace HTML as the application of choice for Web site developers and program creators. A programmer using Flash™ can create an interactive Web site with sophisticated animation and sound, using low bandwidth and small file sizes. The visual presentation of a Web site using Flash™ is referred to as a movie (hereinafter, a “Flash Movie”), which provides a window for displaying information, similar to an HTML page. Flash Movies, unlike HTML pages, stay loaded in a Web browser, or any device with a Flash™ plug-in. Thus, using Flix™ and other Flash™ video encoding programs, producers can create Flash Movies which are platform independent and do not require users to download specific video players.

Further, it is commonly appreciated that Flash™ also includes functionality to create interactive Flash Movies, wherein the visitor to a Web site may use a keyboard or a mouse to jump to different parts of the Flash Movie, enter information on forms, and perform other interactive operations. While Flash™ supports interactivity, currently, there is no system or process which enables producers of Flash Movies to easily and dynamically provide Enhanced Content during the presentation of a Flash Movie. Currently, any such enhancements generally have to be provided by an external server during the presentation of the Flash Movie. U.S. provisional patent application serial No. 60/269,593 of Jeffrey M. Harrington entitled “A SYSTEM AND METHOD FOR CONTROLLING AND/OR SYNCHRONIZING A FLASH PRESENTATION TO A TEMPORAL EVENT WITH A SERVER,” and filed on Feb. 15, 2001 provides a system and process for providing Enhanced Content during a Flash Movie while maintaining server-side control, the contents of which application are incorporated by reference herein in their entirety. However, such a configuration generally requires the external server to be in sync with the Flash Movie and also requires an active communication link between the server and the client device playing the Flash Movie in order for the client to receive the Enhanced Content and the server to control the presentation of the Enhanced Content.

Additionally, producers of multi-media presentations presented over an Internet connection often are concerned with preventing users from gaining ready access to the sources of the multi-media segments. When Enhanced Content is being provided (which may include special offers and other information), ever greater concern is directed towards protecting the identity of the sources of such Enhanced Content. Currently, audio and video programs presented using the Real Player, Media Player or Quicktime players are subject to hacking because they commonly utilize HTTP and HTML to provide the program content. From such transmission mediums and formats, one can readily determine a source of the program segments, including any Enhanced Content. As such, there is a need for a system and process which provides digital rights protection benefits while providing Enhanced Content. Otherwise, content can be fetched and re-used without the owner's permission.

### SUMMARY

Systems and methods for providing Enhanced Content related to a Temporal Signal provided in a Flash Movie by a client device are provided. A Flash Movie providing Enhanced Content consistent with the systems and methods of the present invention is referred to herein as an Enhanced Flash Movie (“EFM”). Utilizing the systems and methods of the present invention, EFMs may be provided without requiring lengthy downloads, specific client devices or multi-media players or operating systems, specific data formats or similar constraints in order to implement the features and functions identified herein. Preferably, EFMs are presented, using a Web browser on a suitable client device (i.e., a device which provides Web surfing capabilities over either a wired or a wireless communications link and/or also provides the capability to obtain EFMs from computer readable medium without requiring or utilizing a communications link). As such, the various embodiments of the systems and methods of the present invention for providing and presenting EFMs are described in the context of a client device having a Web browser which is utilized to receive and present EFMs.

Further, the systems and methods of the present invention create a new, efficient, dynamic, diverse, ubiquitous and powerful educational and entertainment medium. These systems and methods allow consumers to receive more information in a more efficient manner than either television or the Internet alone and over prior systems and processes utilized to present Enhanced Content related to a Temporal Signal. Instead of requiring client systems to execute lengthy, and sometimes problematic downloads, or requiring client systems to download specific media players or maintain continuous connections with servers, the systems and methods provided herein streamline the presenting of Enhanced Content related to a Temporal Signal. For example, a content creation or origination segment of the system supports the encoding of Temporal Signals into Flash Movies. Triggers which contain addresses, such as an URI, for providers of Enhanced Content related to the Temporal Signal may also be encoded into the Flash Movie, thereby creating an EFM. Preferably, the triggers are encoded into the Flash Movie such that external or additional connections are not needed in order for a client device, which is receiving the EFM, to receive the triggers. The Enhanced Content may be provided in conjunction with the EFM or separately and is preferably synchronized to the content of the Flash Movie.

In one system embodiment, the EFM may be played using any standard Web browser that has a Flash plug-in. The EFM includes a Movie Player that enables a client device to play a Flash Movie while the Movie Player monitors the playing Flash Movie for the occurrence of a frame(s) in the Flash Movie for which a trigger has been specified. More specifically, a trigger is included in the EFM which identifies to the Movie Player the frame(s) for which Enhanced Content is available. As the Flash Movie provided in the EFM is being played on the Web browser, the Movie Player is presented on the Web browser as a hidden layer. The hidden Movie Player monitors the status of the Flash Movie and includes a timer and frame counting layer which detects when a specific frame, identified by a trigger in the EFM, occurs in the Flash Movie. When the frame occurs, the Movie Player activates the trigger and the Enhanced Content previously identified in the trigger by an URI or other address is provided to the client device. Alternatively, the Flash Movie could subscribe to a timing software service or device service that would notify the Flash Movie when a given time occurs. Such a timing service could be server-side or client-side and exist outside of the Flash Movie or the Flash application layer itself.

However, in certain embodiments the triggers may also be provided real-time to the Movie Player. For example, a trigger might be pushed in an URI referenced by another trigger associated with the EFM. Preferably, the Enhanced Content is presented in conjunction with the presentation of the Flash Movie provided in the EFM, for example, in a separate window on the Web browser. However, the Enhanced Content may also be presented during an interruption of the Flash Movie or at a later time. By using such a system, consumers can see a video program provided in a Flash Movie while also being presented with Enhanced Content, all of which may be presented via a single client device, for example, on a Web browser partitioned into windows, layers and/or frames.

By utilizing the present invention, the act of viewing a Flash Movie has now become a more engaging, enriching experience because Enhanced Content can now be obtained almost instantaneously without any lengthy downloads, initialization routines, or constraints upon compatible systems or sources, and even without an external connection to a source of the Enhanced Content. An external connection may not be needed, for example, when the EFM and the associated Enhanced Content is provided to the client device at substantially the same time or within the same download or on the same computer readable medium. Such EFM and Enhanced Content might be presented on a computer readable medium (for example, a Compact Disc “CD”, a Digital Versatile Disc “DVD”, or a Super Audio Compact Disc “SACD”). The Enhanced Content may also be provided during a download (for example, a download of streamed or unstreamed video-on-demand or pay-per-view presentation), or even during a broadcast (for example, the Enhanced Content is contained on a separate channel or is suitably encoded into an MPEG or QuickTime packet).

Various embodiments of the systems and methods of the present invention can also create a more intimate relationship between the client and the program. For example, in an educational environment, a student (the client) might be solving problems or performing virtual experiments on an Internet site that a teacher is discussing in an educational program. Unlike previous systems, the present invention enables the student and the teacher to visit the classroom via any device capable of playing an EFM, including wireless devices such as Personal Data Assistants (“PDA”) and wireless communications devices. Such capabilities are possible with the present invention because the invention provides for an EFM which includes triggers to Enhanced Content that can be custom tailored, on the fly, if so desired, as the EFM is being presented. Similarly, pre-set Enhanced Content can also be provided that is triggered as the student progresses through a lesson provided in an EFM. For example, a science experiment being presented in an EFM might include a trigger which provides a link (for example, an URI) to Enhanced Content related to a specific stage of the experiment and providing a choice of options. Depending upon the option chosen by the student, future triggers provided in the EFM (which are suitably directed by URIs to an additional Web site) might be configured to be consistent with the earlier selections by the student. This configuration further enhances the science experiment by providing triggers in the EFM which can point to specific Enhanced Content and/or may be directed to other Enhanced Content based upon viewer choices, viewer profile and other information.

Another advantage of the systems of the present invention is that it changes the nature of advertising. Since additional information can now be given, via the present invention, to consumers automatically and without large downloads or servers synchronized to the presentation of an EFM. Advertising can now be even more interactive, responsive and substantive. Such real-time responsiveness allows customers to make more informed choices and/or spontaneous choices. For example, now, the act of purchasing a product seen in an EFM can be streamlined. The consumer can be given the choice of buying the product instantly using the two-way capabilities of Internet or other bi-directional communication systems, or the consumer can be given the choice of buying the product later by suitably saving the trigger or an URI contained in the trigger. For example, the methods of the present invention enable an Enhanced Content provider to insert a trigger into an EFM, wherein the trigger includes an URI for a specific segment of Enhanced Content. The trigger might even reference a second Flash Movie or even a second EFM which directs the client device to overlay a button or similar indicator, providing the functionality necessary to purchase a product from a remote location, via the display and user interfaces provided by or with the client device. Similarly, the trigger may generically identify an URI, at which a Web site may be configured to route a consumer to a specific segment of Enhanced Content based upon other information, for example, a user profile.

Various embodiments of the present invention also include methods for synchronizing programming in a Temporal Signal with Enhanced Content. By utilizing an EFM that includes triggers containing an URI, functional pushes and/or object pushes of Enhanced Content to users can be accomplished. The EFM may include any form of Temporal Signals, including, but not limited to, audio and video signals. According to one aspect of the present invention, a trigger provides an URI which specifies a location from where Enhanced Content related to the Temporal Signal that has been encoded into a Flash Movie, and/or a segment of the Flash Movie, can be obtained. The Enhanced Content is then retrieved from the location using known systems and processes. It is to be appreciated that the Enhanced Content may include or reference a second EFM or even a second Flash Movie that can be appropriately loaded into a pane, layer, window or even as an overlay of the original EFM. As such, the system may be configured to provide Enhanced Content which may or may not be targeted to specific users and/or audiences and which may or may not involve the use of multiple, possibly overlaid, Flash Movies and/or EFMs.

These and various other features and functions of the various system and method embodiments of the present invention are further discussed herein with reference to the drawings and the detailed description.

### DESCRIPTION OF THE DRAWINGS

FIG. 1 is a schematic representation of first embodiment of a system consistent with the present invention, wherein an URI identifying an EFM is provided in a programming signal and the Enhanced Content triggered by the EFM is received from a server providing the EFM.

FIG. 2 is a schematic representation of a second embodiment of a system consistent with the present invention, wherein an URI identifying an EFM is provided in a programming signal and the Enhanced Content triggered by the EFM is received over an Internet connection.

FIG. 3 is a schematic representation of a third embodiment of a system consistent with the present invention, wherein the EFM is received directly from a server and the Enhanced Content is received over the Internet connection.

FIG. 4 is a schematic representation of a fourth embodiment of a system consistent with the present invention, wherein a computer readable medium provides the EFM and the Enhanced Content is received over an Internet connection.

FIG. 5 is a schematic representation of a fifth embodiment of a system consistent with the present invention, wherein the EFM and the Enhanced Content are both received directly from a computer readable medium.

FIG. 6 is a pictorial illustration of a series of layers which may be utilized in conjunction with the present invention.

FIG. 7 is a pictorial illustration of an embodiment of a Movie Player layer that may be utilized consistently with the present invention.

FIG. 8 is a pictorial illustration of a series of layers which may be displayed upon a Web browser and is consistent with at least one embodiment of the present invention.

FIGS. 9A-9B provide a flow-chart representation of a method for receiving and presenting an EFM consistent with the systems embodiment shown in FIG. 1 and FIG. 2.

FIG. 10 is a flow-chart representation of a method for receiving and presenting an EFM consistent with the system embodiment shown in FIG. 3.

FIG. 11 is a flow-chart illustration of a method for receiving and presenting an EFM consistent with the system embodiment shown in FIG. 4.

FIGS. 12A-12B are a flow-chart illustration of a method for receiving and presenting an EFM consistent with the system embodiment shown in FIG. 5.

FIG. 13 is a flow-chart illustration of a method for loading an EFM into a Web browser provided on a client device.

### DETAILED DESCRIPTION

A first exemplary system consistent with the present invention preferably combines the rich visual capabilities of video with the dynamic capabilities of Flash™ technology, while also embedding triggers within a Flash Movie in order to provide an Enhanced experience that is self-contained within an Enhanced Flash Movie (“EFM”). The first exemplary system preferably refers to video programming, however, the systems and methods described herein are equally applicable to any programming signal including, for example, audio, streaming video, streaming audio, holographic images, virtual reality signals, and any other type of Temporal Signals.

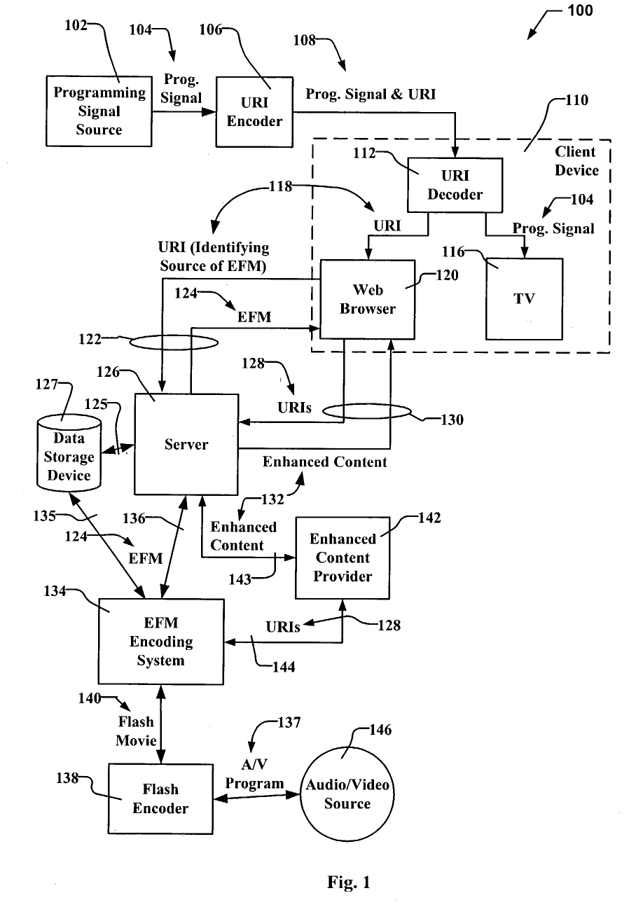

Referring to FIG. 1, an embodiment of a first system 100 for providing and receiving EFMs, in accordance with the systems and methods of the present invention, is provided.

As shown, a programming signal 104 is obtained from a programming signal source 102. URI(s) are encoded into the programming signal 104 by a URI Encoder 106. The combined signal 108, which consists of the programming signal 104 and the embedded URIs 118, is then communicated to a client device 110. Systems and methods for providing a programming signal 104, embedding URIs 118 into such programming signal 104, and providing a combined signal 108 to a client device 110, are described in greater detail in U.S. Pat. Nos. 5,774,664 and 5,778,181 which issued, respectively, on Jun. 30, 1998 and Jul. 7, 1998 to Jack D. Hidary et al., and in U.S. Pat. No. 6,018,768, which issued on Jan. 25, 2000 to Craig Ullman et al., each of which is entitled “Enhanced Video Programming System and Method for Incorporating and Displaying Retrieved Integrated Internet Information Segments,” and each of which are incorporated herein by reference in their entirety. Collectively, the U.S. Pat. Nos. 5,774,664, 5,778,181, and 6,018,768 are referred to hereinafter as the “Enhanced Video Patents.”

As discussed in the Enhanced Video Patents, the programming signal 104 may contain audio signals, video signals and/or other types of Temporal Signals. The programming signal 104 is preferably distributed to clients in their homes over existing communication networks, such as, broadcast, cable, satellite and Internet. The programming signal 104 may be created according to any conventional means known in the art. After the programming signal 104 is created, at least one URI 118 is embedded into the programming signal 104 so as to produce the combined signal 108. Preferably, at least one of the embedded URI(s) 118 identifies a source providing an EFM, for example, a server 126. Further, the URIs 118 may be embedded, in one embodiment, into the Vertical Blanking Interval (“VBI”) of a video portion of the programming signal 104 by the URI encoder 106. In one embodiment, at least one URI(s) 118 identifying an EFM is preferably encoded onto eight fields of line 21 of the VBI. Line 21 is the line associated with close captioning, among other things. However, in other embodiments, the URI 118 could be embedded into other fields of the VBI, in the horizontal portion of the video, as part of the audio channel, in any sub-carrier to the video, or, if digital, in one of the data fields or data packets (for example, one provided in a Motion Picture Equipment Group Standard No. 2 (“MPEG-2”) compliant signal).

As explained in greater detail in the Enhanced Video Patents, the particular information in line 21 of the VBI is not part of the visual part of the programming signal 104, and thus, is not perceptible to the human eye, thereby making it ideal to send data information to the client. While the bandwidth capacity of line 21 is limited, because the system transmits URI(s) and, more specifically, URIs identifying an EFM, and does not transmit the full EFM, there is more than enough capacity. Furthermore, no additional hardware is necessary at the client device 110 to implement this embodiment of the present invention. Thus, the embodiment is very efficient and takes advantage of conventional hardware while providing the expanded capacity of providing URIs 118 which identify sources of EFMs that relate to a programming signal 104.

As shown in FIG. 1, the combined signal 108, containing the programming signal 104 and the URIs 118, is suitably communicated over a common communication link(s). However, systems may also be configured in which the URI(s) 118 are sent to the client device 110 independently of the programming, for example, on a separate data channel, in a separate data packet, or via a unique communications link.

Further, it is to be appreciated that URIs 118 identifying providers of EFMs may also be provided to client devices 110 prior to initiation of the programming signal. In such an embodiment, the URIs 118 may be provided in a separate download to the client device 110 and then suitably stored in a memory or data storage device associated with the client device 110.

Similarly, the programming signal 104 and/or the combined signal 108 may also be communicated as a live or pre-recorded signal to the client device 110. These signals 104 and/or 108 may be communicated via any known communications systems including, but not limited to, broadcast, cable, Internet, and satellite systems. Such communications may be pre-set (for example, based upon a network broadcast schedule), may be real-time (for example, when a breaking news event occurs), and/or may be on-demand. For example, the programming signal 104, the URIs 118, and/or the combined signal 108 may reside on audio and/or video servers until requested by a client (for example, as a video on demand).

Furthermore, the programming signal 104, the URIs 118, and/or the combined signal 108 may also be provided in a VHS or Beta tape format and presented via a local VCR. Digital encoding of the programming signal 104, the URIs 118, and/or the combined signal 108 may also be recorded on a CD or DVD and subsequently presented via a DVD player at the client device 110. The VCR, CD/DVD player or other components may be as a stand-alone unit, as part of an integrated system, as part of a networked system (for example, a home network), or even provided in a personal computer or similar device. Also, digital recording mechanisms and devices, such as a TiVO® unit, may be utilized to record and/or play-back any recordings of the programming signal 104, the URIs 118, and/or the combined signal 108.

Further, the recording of the programming signal 104, the URIs 118, and/or the combined signal 108 may be accomplished local to or remote of the client device 110. Also, the programming signal 104, the URIs 118, and/or the combined signal 108 may also be in an analog format or a digital format (for example, a signal that is compliant with one of the various MPEG standards). Thus, it is to be appreciated that the programming signal 104, the URI(s) 118, and/or the combined signal 108 may be obtained from a variety of sources at varying times.

In the embodiment shown in FIG. 1, the embedded URI 118 is extracted from the combined signal 108 by a local URI decoder 112. The URI decoder 112 may be either a stand-alone unit, a card that is connected to the client device 110, or an application running on the client device 110. Alternatively, the URI decoder 112 may be located at a server connected with the network. When the URI decoder 112 receives the combined signal 108, it separates the URI(s) 118 from the audio/video programming 114. The URI(s) 118 are provided to a Web browser 120 while the programming signal 114 is provided to a presentation device, such as a television 116. In the embodiment shown in FIG. 1, the URI decoder 112, the television 116 and the Web browser 120 are shown as being elements of a single client device 110, for example, an Internet ready television that includes an URI decoder (which may be accomplished via either hardware or software) and that utilizes picture-in-picture, windows, frames or other techniques to present the programming signals 104 while also providing the features and functions associated with a Web browser.

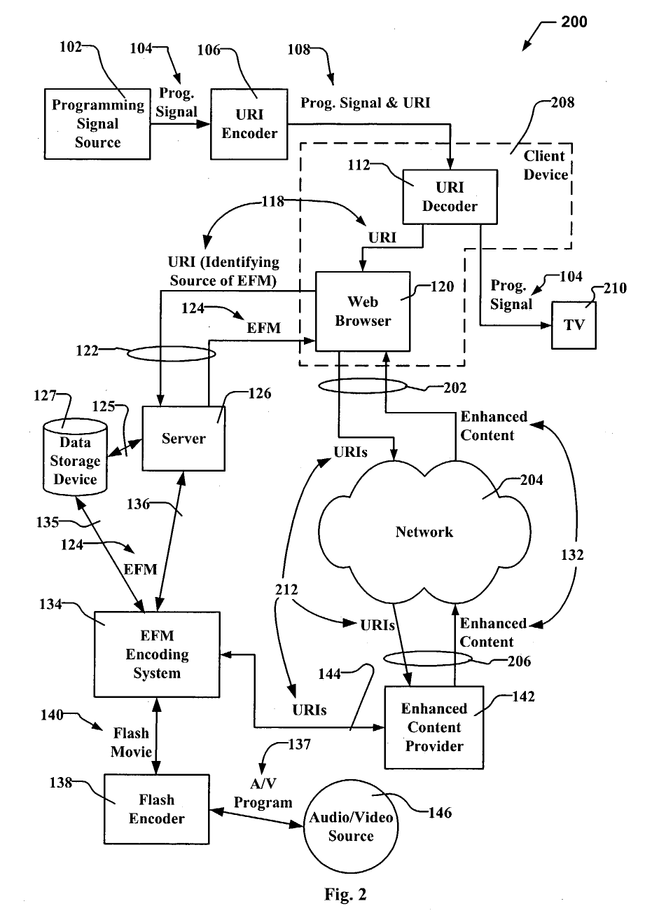

However, it is to be appreciated that the presentation device(s) utilized to present the programming signals 104 may be the same as or separate from the device(s) utilized to provide the URI decoder 112 and/or the Web browser 120. For example, in the embodiment shown in FIG. 2, the client device 208 is depicted as including the URI decoder 112 and the Web browser 120, while the TV 210 (or other presentation device utilized to present the programming signal 104) is depicted as a separate, stand-alone device. Further, it is to be appreciated that the URI decoder 112, the Web browser 120 and the television/programming signal presentation device 116/210 may each be distinct devices that are suitably interconnected, i.e., via wired or wireless connections. Other combinations of integrated and stand-alone components and devices may be utilized to provide the functions of the client device shown in FIG. 1 and FIG. 2. Namely, such functions include the capability to separate URI(s) 118 and programming signals 104 from a combined signal 108 and to provide each to their respective presentation devices, i.e., the Web browser 120 and the TV 116, respectively, such that an EFM 124 (i.e., the Flash Movie and Enhanced Content associated with the Flash Movie) can be presented in synchronization with a programming signal 104.

In certain applications, the Web browser 120 may be configured to automatically establish a communications link 122 with the server 126 upon the receipt of the URI 118; such a configuration is often referred to as a “push”. Similarly, the Web browser 120 may also be configured to establish the link 122 with the server 126 upon the receipt of an URI 118 and a command from a client directing the Web browser 120 to retrieve the EFM 124; such a configuration is often referred to as a “pull”. As such, the client device 110 may be configured to be “pushed” or to “pull” EFMs identified by an URI 118 provided in conjunction with a programming signal 104.

More than one presentation device may be utilized to present the programming signal 104, the EFM 124 and/or other Enhanced Content. As shown in FIG. 1, when two separate presentation devices are being utilized to receive EFMs 124 and the programming signal 104, the URI decoder 112 suitably routes the programming signal 104 to a suitable presentation device(s), for example, a television 116, a home theater system, a sound reproduction system, and/or another device used to present the programming signal to a client. Additionally, in FIG. 1, the TV 116 and the Web browser 120 are depicted as being two components provided for in a client device 110. These components (the TV 116 and the Web browser 120) may be provided in a single presentation device, such as a personal computer equipped with a video card or an Internet ready television. Similarly, the URI decoder 112 may be built into a television, configured as a set-top box, or even provided in software being implemented by a suitable computing device (such as, a personal computer, a PDA, or a game console, e.g., a PlayStation 2™).

Referring again to the URI decoder 112 of FIG. 1, this decoder 112 also preferably routes the URI(s) 118 to a device configured to receive URI(s), such as a Web browser 120 on a personal computer, a set-top box, a digital TV, a wireless device, a gaming console, a wireless telephone, a PDA or any other device capable of presenting a Flash Movie. Since the URIs 118 identify EFMs 124, which require Flash capabilities, preferably the Web browser 120 includes a Flash™ player. However, the client device 110 may also be configured with a stand-alone Flash™ player (i.e., a Flash™ player that operates independent of or in conjunction with a Web browser in order to present EFMs). Currently, any Flash™ equipped Web browser (for example, a Microsoft® Internet Explorer® or Netscape® Navigator™ browser) is capable of presenting an EFM without modification to the EFM or the Web browser. As shown in FIG. 1, for the first embodiment of this system 100, a Flash™ compatible Web Browser 120 is utilized to present the EFM 124.

However, it is anticipated that as Flash Movies, in general, and EFMs, in particular, become more ubiquitous, devices will be provided for presenting Flash Movies and/or EFMs without requiring or utilizing the full capabilities of a Web browser. As such, the client device 110 preferably may be configured to provide a platform for receiving URI(s) 118 and presenting EFM(s) 124 in conjunction with or separate from the reception and presentation of a programming signal 104. Such a client device may not require or utilize the full capabilities of a Web browser operating on a personal computer or similar device. Thus, it is to be appreciated that for the system 100 shown in FIG. 1, the client device 110 provides the capabilities of identifying, locating, retrieving and presenting EFMs in conjunction with a programming signal by utilizing URIs or other schemes for identifying local and/or remotely located Temporal Signals and/or Enhanced Content related to such Temporal Signals.

In one embodiment, the URI(s) 118 have associated time stamps, which indicate to the client device 110 when, during the programming signal, to fetch and play an EFM which can be obtained from a server 126 or other device identified by an address specified by the URI 118. As shown in FIG. 1, a server 126 is illustrated as being associated with the address provided in the URI 118 and as providing the EFM 124 to the Web browser 120. It is to be appreciated, however, that any device, which may be identified by an address or similar designator and from which an EFM may be obtained, can function as the server 126. For example, when the EFM 124 associated with a given URI is provided on a CD or DVD, the URI 118 may refer to a location on such computer readable medium at which the data of interest (i.e., the EFM) is stored. In such an embodiment, the DVD player effectively operates as the server 126 by providing the EFM 124 to the client device 110 and/or Web browser 120. In one preferred embodiment for this system 100, however the URI 118 suitably identifies a server accessible via a network, for example, the Internet.

For the embodiment shown in FIG. 1, the Web browser 120 suitably communicates with a server 126 and provides any URIs 118 received from the URI decoder 112 to the server 126 over a suitable communications link 122. In FIG. 1, two communication links 122 and 130 are illustrated. Such illustrations are for the purposes only of identifying the types of information commonly communicated by the Web browser 120 to the server 126 and vice versa. Those skilled in the art should appreciate that a single, bi-directional communications link is commonly adequate for facilitating communications between a Web browser 120 and a server 126, and that separate links are not needed. However, in certain embodiments, wherein high speed communications are utilized, parallel and/or numerous communication links may be utilized. Further, the various communications links shown in FIG. 1 are provided for illustrative purposes only and are not be construed as depicting an actual or preferred hardwire configuration. As is commonly appreciated, Web browsers 120 commonly connect with a server 126, associated with a particular URI 118, via the Internet, a Local Area Network (“LAN”), a wired network, a wireless network, a combination wired and wireless network and/or a Distributed Community Network (“DCN”). For a description of a DCN, see U.S. patent application Ser. No. 09/396,693, which was filed on Sep. 15, 1999 in the name of inventors Craig Ullman et al., and is entitled “Enhanced Video Programming System and Method for Providing a Distributed Community Network”, the contents of which are herein incorporated by reference in their entirety.

In FIG. 1, the server 126 is shown as existing separate from the programming signal source 102 and/or any of the components or communication links by which the combined signal 108 is communicated to the client device 110. However, the server 126 may also reside with the programming signal source 102, be a part of the communications network providing the programming signal 104 to the client device (for example, a server located at the cable head-end or the broadcast center for a satellite system) and/or be associated with the Enhanced Content provider 142 or any other segment of the system 100.

Further, a producer of a programming signal may issue commands which in real-time direct the type of Enhanced Content provided to the client device during the presentation of a programming signal. Such commands may direct a client device to present single or multiple instances of an EFM. Additionally, the combined signal may also include URIs specifying other Enhanced Content segments which are to be presented in conjunction with the presentation of Enhanced Content segments specified in an EFM. For example, a client device might be configured such that a Web Browser presents the EFM and the Enhanced Content related directly thereto, while a television presents the programming signal and other Enhanced Content which may or may not relate to the EFM. Thus, it is to be appreciated that as the presentation capabilities of a given client device increases, the number of occurrences and the relation of Enhanced Content to the programming signal and/or an EFM may also increase. Further, the capacity of a given client device to present EFMs, Enhanced Content and/or programming signals is commonly determined by the number of presentation devices attached to the client device and/or the capabilities of such presentation devices.

Referring again to FIG. 1, the server 126 receives the URI 118 from the client device 110 (via the Web browser and a communications link 122 established between the server 126 and the client device 110). The server 126 also suitably retrieves EFMs 124 from either a data storage device 127, via communications link 125, or from an EFM Encoding System 134, via communications link 136. The retrieval and accessing of a stored EFM from a data storage device 127 may utilize any known systems and methods and/or communications links for accessing stored computer data and information. However, it is to be appreciated that certain EFMs may contain large quantities of information and therefore high speed communication links may be desirable in order to timely access and provide an EFM to a client device 110 via the server 126.

Essentially, the Web browser and the server 126 utilize commonly known TCP/IP, UDP, and/or other Internet protocols to query the server 126 to provide the desired EFM (i.e., the EFM identified by the URI) and, in response to such query, to transfer the EFM 124 to the Web browser 120. The server 126 also receives URIs 128, via communications link 130, that have been extracted from the trigger provided in the EFM 124 by the Web browser 120. Similarly, the server 126 provides, via the communications link 130, Enhanced Content 132 related to the content of a Flash Movie provided in the EFM 124.

In providing an EFM 124, the server 126 suitably obtains the EFM 124 from a source. As discussed previously, the EFM 124 is preferably composed of a Flash Movie, a Movie Player, and at least one trigger. The triggers preferably are related to and depend upon the content of the Flash Movie. More specifically, in the preferred embodiment, each trigger includes at least two elements, a reference and an identification of the Enhanced Content to be presented to the client based upon the occurrence of the reference. For the preferred embodiment, a trigger is configured as a mean value pair data structure with a variable identifying the trigger and a value identifying the action to be taken. Further, in the preferred embodiment, the value segment of the trigger includes a frame number and an URI. As discussed in greater detail hereinbelow the URI is suitably called when the frame specified in the trigger occurs in the Flash Movie provided in the EFM. Three examples of a trigger are as follows:

| Trigger Name (Variable) | Frame Number, URI (Value) |
|---|---|
| trigger1 | 50:http://www.hypertv.com/push1.swf |
| trigger2 | 250:http://www.hypertv.com/push2.swf |
| trigger3 | 500:http://www.hypertv.com/push3.swf |

As shown, each trigger includes a reference (for example, 50 or 250 or 500) to a specific frame of the Flash Movie being provided in the EFM. Additionally, the identification of the Enhanced Content includes an address (for example, an URI such as, “http://www.hypertv.com/push1.swf”) that identifies a source from which specific Enhanced Content can be automatically or upon command retrieved by the server 126 and provided to the Web browser 120 upon the occurrence of the associated frame in the corresponding Flash Movie. Further, the Enhanced Content 132 referenced by the URI 128 and extracted from the trigger preferably relates to the content of the Flash Movie 140 being provided in the EFM 124.

However, while the preferred embodiment preferably utilizes triggers that are referenced to a frame count and provides URIs identifying specific segments of Enhanced Content, it is to be appreciated that various other triggers and/or identifications may be provided. For example, the triggers may include references to other occurrences (or even non-occurrences) such as an elapsed playing time, a time of day, the amount of time remaining in a Flash Movie, a failure by a client to respond to a query, or a reference to any other temporal, functional (for example, a response by the user to a prompt or the receipt of a command in the programming signal 108 from a producer, wherein the command instructs the Movie Player to activate the next value obtained from a mean-value-pair data structure), or other variable. Further, the address portion of the trigger may include an identification to sources of information, such as Enhanced Content, or may include an identification to other addressable items. Such addressable items may include, for example, segments of program code, other programs, other EFMs, Enhanced Content, interactive Enhanced Content and any other form of information, data, program code, instructions or the like which is computer addressable. Further, triggers may also be provided as commands to execute methods set forth in code, e.g., a code which instructs the program to change its color or show a hidden graphic.

Therefore, it is to be appreciated that the sources of EFMs may includes triggers that are functional and that provide addresses to segments other than purely Enhanced Content. For example, a functional trigger might be provided as an element of, or a sub-part of, a trigger that is configured to be activated upon the occurrence of a specific frame in a Flash Movie. Such a functional trigger might provide that upon the occurrence of frame 50, for example, the client device retrieves a segment of program code that provides Enhanced Content while also being responsive to user inputs. Upon receiving such user inputs, the trigger might be directed to call other EFMs, other Enhanced Content, other triggers, or other functionalities. Thus, in this example, the EFM includes triggers to other Enhanced Content, which may include interactive features, information to be presented to the client (for example, audio and/or video segments), or even other EFMs that are to be loaded and presented during, in substitution for, or during an interlude in the original EFM. Further, the original EFM and any subsequently triggered Enhanced Content may even be synchronized to the original programming signal.

As further shown for the embodiment in FIG. 1, the EFM 124 may also be suitably provided real-time to the server 126 over communication link 136 by an EFM Encoding System (“EFMES”) 134. The EFMES integrates URIs 128 received from an Enhanced Content Provider 142 into a Flash Movie 140 received from a Flash Encoder 138; wherein the Flash Movie includes a Flash encoded audio and/or video program 137 that has been provided by an audio/video source 146. More specifically, the EFMES 134 provides triggers in the EFM 124 which indicate when to provide the URI 128 to the client device 110 such that the client device may retrieve the Enhanced Content 132 related to the Flash encoded audio/video program. The EFMES preferably uses the WildFlix™ application to encode triggers in Flash Movies. Additionally, triggers can be fetched and encoded using a connection to a server, a file based resource or using Flash 6™ and/or other video compiling software.

Referring now to FIG. 2, another embodiment of a system for providing EFMs is depicted. As shown in this system 200, the Web browser 120 provided in the client device 208 suitably establishes two communications links 122 and 202. The first communications link 122 is established by the Web browser 120 upon the receipt of the URI 118 identifying the EFM 124 related to the programming signal 104. As discussed previously with respect to FIG. 1, the Web browser 120 establishes the communications link 122 with the server 126 providing the EFM 124. Once the EFM 124 is loaded into the Web browser, including the loading of the Movie Player, the Web browser 120 presents the Flash Movie 140 provided in the EFM 124 while also monitoring, via the Movie Player, the frame count of the playing Flash Movie 140 for the occurrence of a frame with which a trigger is associated. Once such a frame is detected, the trigger is suitably activated. As discussed previously, the trigger preferably includes an URI 212 or other address that identifies a provider 142 of Enhanced Content 132 which relates to the playing Flash Movie 124, and/or a specific frame of the Flash Movie 124.

As shown in FIG. 2, the URI 212 may suitably direct the Web browser to establish a second communications link 202, via the Internet 204, to an Internet Service Provider (not shown) which then establishes a third connection 206 with the Enhanced Content provider 142. It is worth noting that the Enhanced Content provider 142 may be the same provider as that provided for in the embodiment shown in FIG. 1, wherein the differences between the system embodiments resides in whether the Enhanced Content 132 provided by the Enhanced Content Provider is provided directly via the server 126 (as shown in FIG. 1) or via the Internet 204 or a similar network connection (as shown in FIG. 2). Thus, it is to be appreciated that the system may be configured such that triggers direct the client device 110/208 to utilize a single Web browser, with a connection(s) to a single server 126 via which both EFMs and Enhanced Content are provided. Also, the system may be configured such that triggers, via the Movie Player, direct the client device to open multiple Web browsers, wherein a first Web browser receives and presents the Flash Movie provided in the EFM, while second and other Web browsers request, receive and present Enhanced Content related to the Flash Movie playing on the first Web browser. Further, it is to be appreciated that such multiple Web browsers may be presented simultaneously or serially on a single display device (for example, as windows or frames) or on multiple display devices.

The embodiment shown in FIG. 2 also provides the functionality of separating the providing of the Enhanced Content from the providing of the EFM, the Flash Movies and triggers associated with the EFMs. This separation make possible additional functionalities not commonly available in the prior art. For example, the providing of URIs in programming signals enables producers of the programming signal to be removed and unconcerned with the association of Enhanced Content with such programming signal. Similarly, the utilization of Flash™ in conjunction with URIs, enables Enhanced Content providers to be unconcerned with the platform upon which the Enhanced Content is to be presented on the client device, i.e., any Web browser works.

Similarly, the utilization of EFMs enables Enhanced Content providers to be removed from the control and timing issues present in Flash embodiments that utilize a server to control the synchronization of the Enhanced Content with the presentation of a Flash Movie. The system embodiment shown in FIG. 1 removes the server from such real-time control concerns by utilizing triggers and the Movie Player. Lastly, the embodiment of FIG. 2 removes the server 126 from the concern of providing the Enhanced Content identified by the triggers in the EFM. Instead, the server 126 merely provides the EFM. It is to be appreciated the EFM may also be provided by a system or device other than a server, for example, a CD, DVD (or other portable readable medium), data storage device, or otherwise.

Further, once the EFM is provided, the server 126, in the embodiment shown in FIG. 2, is suitably separated from providing the Enhanced Content. As such, the Enhanced Content that is to be provided during the presentation of the Flash Movie provided in the EFM, may be predetermined or may be determined real-time. For example, a producer (which may be human or automated) may real-time determine which Enhanced Content segments to provide to a given client device 208 based upon various factors, such as the content provided in a given Temporal Signal, a user profile associated with the client device or an identifier for the client device. Such functionality may be accomplished by inserting an URI which directs the Web browser to a first Web site. Upon receiving the connect request from the Web browser, the first Web site may utilize ISP addresses, and other information provided by the Web browser to determine to which of a plurality of Web sites the client should be redirected. Processes for redirecting a Web browser to subsequent web sites are commonly known in the art, any of which may be suitably utilized in conjunction with the systems and methods of the present invention. Thus, the embodiment shown in FIG. 2 enables the function of providing Enhanced Content to be removed, when desired, from the function of providing the programming signal 104 and/or the EFM 124.

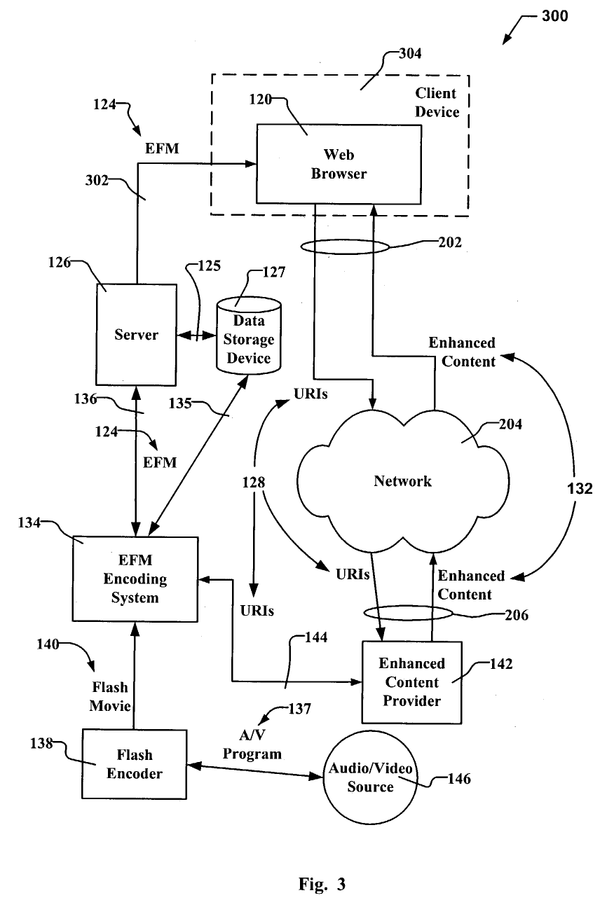

Referring now to FIG. 3, another embodiment of a system of the present invention is depicted. In this embodiment, a combined signal 108 (as provided in FIG. 1 and FIG. 2) is not received by the client device 304, instead the client device 304 merely receives an EFM 124 from the server 126. As such, in this embodiment, a URI decoder is not utilized. Instead, the client device 304 establishes a connection with the server 126 and either requests an EFM 124 to be provided to the client device (304), i.e., a “pull” occurs, or the client device 304 is automatically provided with the EFM 124, i.e., a “push” occurs. In either scenario, the client device 304 receives the EFM 124 without requiring the client device to receive or utilize URIs embedded or provided in conjunction with a programming signal. As such, the system 300 shown in FIG. 3 provides a stand-alone system for receiving and presenting EFMs to a client. Such a stand-alone system 300 suitably operates at any location from which a connection 302 with the server 126 may be established. As discussed previously, such connection 302 may be provided via wired and/or wireless communications links.

The system 300 also may be configured to utilize either of the embodiments shown in FIG. 1 and FIG. 2 for requesting and receiving the Enhanced Content 132 associated with the EFM 124. In FIG. 3, the system 300 is depicted as utilizing a communications link 202 that is connected via a network 204 (such as, the Internet) and additional communications links 206 (as needed, but not required) with an Enhanced Content provider 142. In this embodiment, the server 126 providing the EFM 124 may or may not be associated with and/or co-located with the Enhanced Content provider 142. However, it is to be appreciated that the embodiment shown in FIG. 1 may also be utilized (i.e., wherein the client device receives the Enhanced Content from the same server providing the EFM). Therefore, the system 300 illustrates that the EFM 124 may be provided without requiring the receipt of a combined signal or an URI otherwise provided in conjunction with a programming signal.

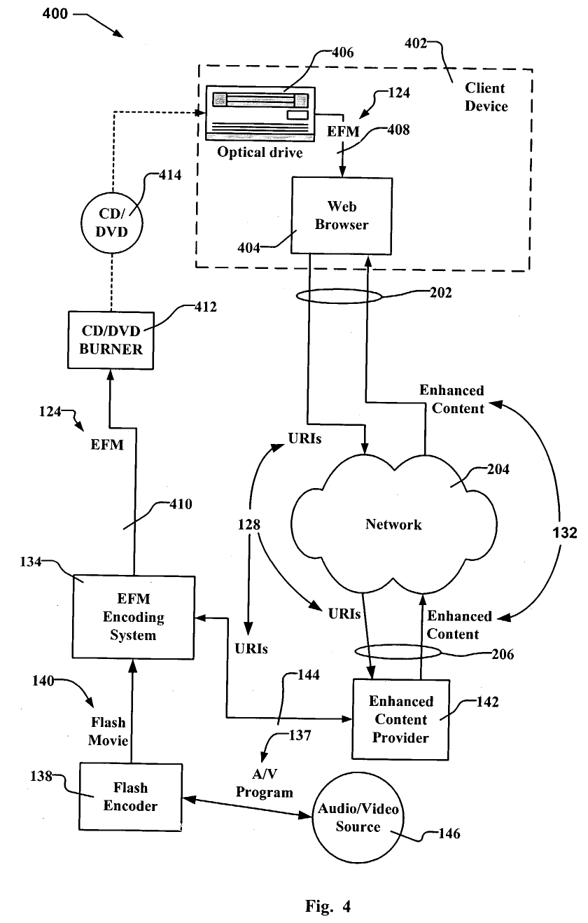

Referring now to FIG. 4, another embodiment of a system 400 for implementing the present invention is depicted. In this embodiment, the client device 402 includes Web browser 404 and an optical drive 406. The Web browser 404 is suitably connected, via connection 408, to the optical drive 406. Further, instead of utilizing a communications link to receive the EFM 124, a CD/DVD burner 412 is utilized by those providing/producing a CD/DVD 414 containing the EFM 124. The CD/DVD burner 412, or a comparable computer readable medium producing device, suitably records the EFM 124 onto a CD/DVD 414. The CD/DVD 414 may then be distributed to the client, using known distribution channels, such that the client may insert the CD/DVD 414 into the optical drive 406 and be presented with the EFM 124 via the Web browser 404 or similar presentation device. It is to be appreciated that the optical drive 406 maybe substituted with or provided in conjunction with other devices capable of reading a computer readable medium, such as but not limited to, a magnetic tape or floppy disc drive or other magnetically readable/writeable media.

One example of where such an embodiment might be used is in the distribution of an audio CD, a DVD, a DVD-Audio disc, or an SACD (hereinafter, collectively referred to as a “CD/DVD”). Often musicians desire to include music video clips that relate to a song playing on the CD/DVD 414. By utilizing the systems and methods of the present invention, the musicians can record the audio recording into a Flash Movie and include triggers in the Flash Movie which relate to Enhanced Content that can be presented on the Web browser of the client device during the playback of the recorded music. Similarly, the music video may be encoded into an EFM on the CD/DVD 414 with triggers being provided to audio files or other forms of Enhanced Content (for example, games, trivia contests, or other information) that can be presented during the music video (i.e., during the presentation of the EFM).

As provided for in FIGS. 1-3, the system 400 preferably utilizes a communications link between the Web browser 404 and an Enhanced Content provider 142 to receive the Enhanced Content 132 identified by the triggers inserted into the EFM 124 by the EFM encoding system 134. As previously discussed hereinabove, the communications link between the Web browser 404 and the Enhanced Content provider 142 is preferably via the Internet 204, however, it is to be appreciated that direct connections, connections via servers or LANs, or other connections may be utilized by the Web browser 404 to request and receive the Enhanced Content 132 from the Enhanced Content provider 142.

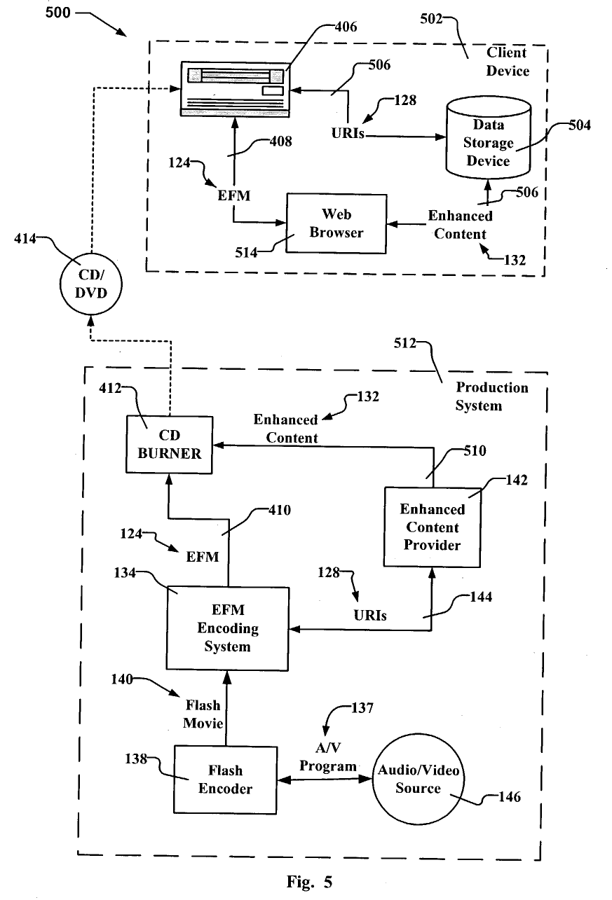

Another embodiment of a system for receiving an EFM and receiving Enhanced Content related to a Flash Movie being provided in the EFM is shown in FIG. 5. In this embodiment, a distinction is drawn between a client device 502 and a production system 512. However, those skilled in the art appreciate that the distinction between capabilities of client devices and production devices is often blurred with either providing similar capabilities.

As provided for with the previous embodiments, the client device 502 suitably presents Temporal Signals encoded into a Flash Movie to a client via a compatible presentation device, such as a Web browser 504. Further, the client device 502 also provides the capability to retrieve Enhanced Content 132 in response to the receipt of a trigger containing an address (for example, an URI 128) for a provider of Enhanced Content 132 during the presentation of a Flash Movie provided in an EFM 124. For this embodiment, the Enhanced Content 132 is retrieved either directly from a computer readable medium, such as a CD/DVD 414, or is retrieved from a file stored in a data storage device 504. The Web browser 514 suitably directs the retrieval of the Enhanced Content 132 from a memory or data storage device 504, the optical drive 406 or a similar component. The data storage device 504 may be co-located with the Web browser 404, but it may also be remotely located with respect to the client device 502.

When the Enhanced Content 132 is to be retrieved from the data storage device 504, the Enhanced Content 132 is provided on a CD/DVD 414, extracted from the CD/DVD by the optical drive 406 and/or stored in the data storage device 504. However, the Enhanced Content 132 may also be retrieved from a provider of Enhanced Content over an Internet connection or similar link, as provided for in FIGS. 1-3, and then stored in the data storage device 504. In the embodiment shown in FIG. 5, the CD/DVD 414 providing the EFM 124 also provides the related Enhanced Content 132. More specifically, upon insertion of the CD/DVD 414 into the optical drive 406, the optical drive 406 reads those sectors of the medium containing the Enhanced Content 132 and stores such content on the data storage device 504. Since neither the CD/DVD 414 nor the EFM 124 may contain a reference to the storage location of the Enhanced Content in the data storage device 504, the identification of the Enhanced content (as referenced by the trigger(s) contained in the EFM) and the identification of the location at which the Enhanced Content has been stored in the data storage device 504 is provided in a look-up table suitably stored in RAM or in another readily accessible memory or data storage location.

Further, with the advent of CD/DVD burners on client devices, it is also possible to encode the look-up table, or other designator of where the Enhanced Content has been stored, onto specific segments of the CD/DVD, for example, segments that have been left unrecorded specifically for such purposes. Thus, it is to be appreciated that when both the EFM 124 and the Enhanced Content related thereto are provided on a single computer readable medium, and the Enhanced Content may be stored in a data storage device 504. Additionally, some addressing schemes may be utilized, as necessary, to correlate the URIs provided in the triggers in the EFM 124 with the actual storage location of the Enhanced Content in the data storage device 504, the computer readable medium or otherwise.

Alternatively, it is to be appreciated that the EFM 124 and/or the Flash Movie may be initially loaded, via the optical drive 406, from the CD/DVD 414 into a data storage device 504 and the Enhanced Content retrieved directly from the CD/DVD 414. In such an embodiment, the triggers in the EFM 124 refer to sectors, tracks or other identifiers on the CD/DVD 414 at which the Enhanced Content 132 may be found. In such an embodiment, look-up tables may not be necessary in order to correlate an URI identified in a trigger with the actual location of the referenced Enhanced Content on the CD/DVD.

As discussed above, it is also possible to provide the Enhanced Content 132 separate from the CD/DVD 414 providing the EFM 124. In such an embodiment, the Enhanced Content 132 may be provided by additional computer readable medium(s) and/or via downloads (which may occur real-time or in advance) from a site providing the Enhanced Content. Thus, it is to be appreciated that various methods and apparatus exist for retrieving Enhanced Content related to a Flash Movie provided in an EFM, and that the EFM may be provided over data communication links and/or via computer readable mediums.

As stated above, the system 500 also includes, for purposes of illustration, a production system 512. The production system 512 includes many of the system components previously identified with respect to FIGS. 1-4. However, in this embodiment a connection is not established between the client device 502 and the production system 512. Instead, the interaction between such devices is provided via a computer readable medium, such as a CD/DVD 414. Further, with respect to FIGS. 4 and 5, the computer readable medium has been illustrated and discussed with reference to a CD/DVD 414. It is to be appreciated that the computer readable medium may be any suitable data storage and transfer device including, but not limited to, floppy discs, memory sticks, game cartridges, flash memory, VHS or Beta tape, or the like. Further, the client device 502 may be configured to include any device(s) necessary to read the computer readable medium, regardless of the format utilized.

Referring again to the production system 512 of FIG. 5, this system 512 includes those elements necessary to create a computer readable medium containing an EFM. In FIG. 5, such elements are illustrated as including an Audio/Video source 146 which is connected to a Flash encoder 138. The Flash encoder 138 outputs a Flash Movie 140 which is provided to the EFMES 134. Further, the EFMES 134 receives an URI(s) 128 from an Enhanced Content provider 142. The EFMES 134 creates the EFM 124 by inserting triggers into the Flash Movie 140. The EFM 124 is then provided to a CD burner 412, or comparable device, which suitably records the EFM 124 and/or the Enhanced Content 132 provided by the Enhanced Content provider 142. As such, a CD/DVD 414 is created which includes an EFM and the Enhanced Content 132 identified by triggers inserted into the EFM 124.

It is to be appreciated, however, that the components and processes utilized to provide the CD/DVD 414 may vary as particular needs dictate. For example, when the CD/DVDs 414 are being mass produced, those devices commonly utilized to mass produce CDs/DVDs may be utilized in lieu of the CD burner and/or other components depicted in FIG. 5. Thus, the production system 512 shown is primarily for illustrative purposes and is not to be construed as limiting the systems and/or devices utilized in actually producing a CD/DVD containing an EFM with or without the associated Enhanced Content. Further, those skilled in the art appreciate that the various components and devices utilized to create a Temporal Signal, Enhanced Content related thereto, encode the Temporal Signal into a Flash Movie, and ultimately produce the EFM do not need to be co-located and may be remotely located with respect to other elements of the system 512.

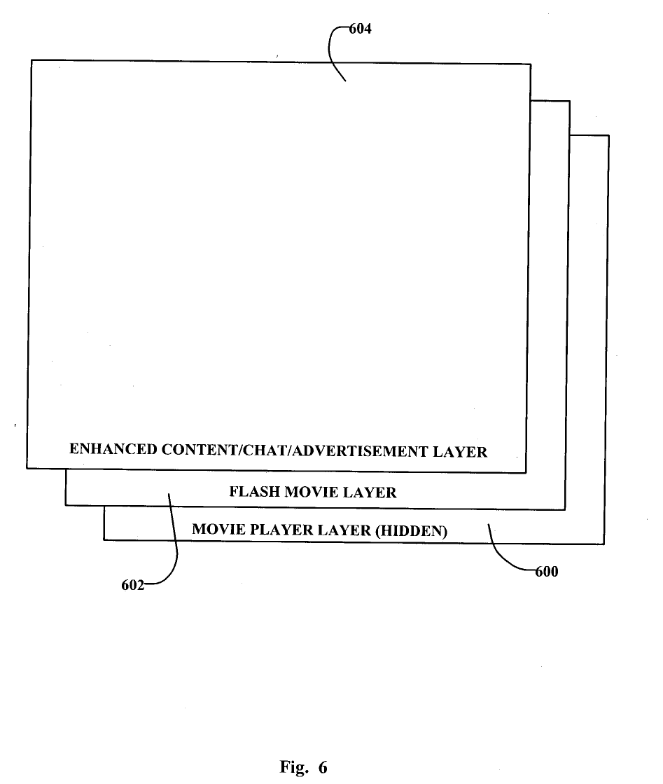

As discussed previously, FIGS. 1-5 provide various system embodiments for producing, distributing, communicating and presenting an EFM. FIG. 6 provides an illustration of one embodiment for an EFM being presented on a client device. As shown for this embodiment, when the EFM contains video segments, it is presented on the presentation device as a series of layers 600, 602 and 604. As is commonly known and discussed further herein, a single layer or various combinations of layers may be viewed by a client at any given time on a presentation device. The layers include a Movie Player layer 600 (the “Movie Player”), a Flash Movie layer 602, and an Enhanced Content/Chat/Advertisement Layer 604, each of these layers are described in greater detail hereinbelow. Additional layers may also be presented on the presentation device.

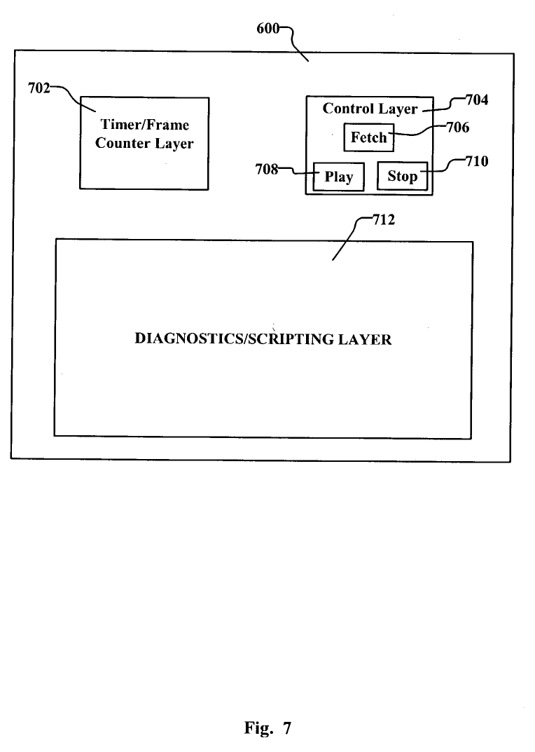

With reference to FIG. 7, the Movie Player 600 is the base Flash layer that enables the functionality of providing Enhanced Content that is synchronized to the presentation of a Flash Movie. The Movie Player 600 provides a control surface/layer which enables a client device to present a Flash Movie while also utilizing triggers to determine when Enhanced Content is to be presented during the Flash Movie. The Movie Player 600 is provided as a Flash Movie that is designed to call, monitor and control the operation of other Flash Movies. When an EFM is to be presented on a client device, the Movie Player is downloaded first such that the client device has those functionalities which are utilized when presenting an EFM and utilizing triggers to identify Enhanced Content and present such Enhanced Content to the client. The Flash Movie provided with the EFM and the triggers are then suitably controlled by the Movie Player 600.

More specifically, the Movie Player includes various functionalities, which may be presented to a client, in order for the client to control the presentation of the EFM or may be hidden from the client and activated automatically. These functionalities include a Timer/Frame Counter layer 702 which enables the client device to count the frames in a Flash Movie. When a specific frame is reached in the Flash Movie, a segment of Enhanced Content may be called by the Movie Player 600 and presented to the client in the Enhanced Content layer 604 (as shown in FIG. 6).

More specifically, the Timer/Frame Counter layer 702 provides a call feature, a “timer movie”, which repeatedly updates the frame count based upon the occurrence of a clip event in a Flash Movie. Those skilled in the art appreciate that a Flash Movie is basically an animation of a series of graphic images that occur at such a rate that the presentation is perceived by a client as a full motion video. Further, it is commonly appreciated that each segment or frame of the Movie is identified by a clip event providing a frame number and other information needed to render the frame. As such, the timer movie identifies the occurrence of each clip event, i.e., the occurrence of the frame. Since the Flash Movie often times may be fast forwarded, reversed, paused, or the like, the timer movie can read the clip events and determine the corresponding frame number regardless of which frame of the Flash Movie is presently being presented.

Further, the Movie Player and the actual Flash Movie operate at the same rate, such that whenever an update occurs for the Movie Player, the timer movie determining the current frame of the Flash Movie is in synch with the update cycle. In at least one embodiment, the frame rate is set at 12 frames per second. However, other frame rates may also be utilized, as desired, and the present invention is not to be construed as being limited to any specific frame rate. In order to ensure the timer movie and the Flash Movie both start at the same reference point when determining a frame number, whenever a Flash Movie is loaded, the Movie Player suitably resets the timer movie upon receipt of the first frame of the Flash Movie. As such, the Timer/Frame Counter layer 702 provides a timer movie that keeps track of what frame the Flash Movie is on and provides such information to the Movie Player on the update cycle specified by the Movie Player.

The Movie Player 600 also may include a control layer 704. The control layer 704 provides those control functions commonly desired when presenting a Flash Movie. These controls include buttons for fetching 706 an EFM and for playing 708, stopping 710, rewinding (not shown), forwarding (not shown) and otherwise controlling a Flash Movie. Additionally, the control layer 704 may also be used to control Flash Movies that have not been enhanced with triggers.

As discussed previously, a given EFM may be fetched upon client request (i.e., pulled) or may be provided automatically (i.e., pushed to the client device). Often it may be desirable for the control layer 704 to be visible to the client on the presentation device, for example, when the client is actively “pulling” the EFM. However, in a push environment, the control layer 704 may not need to be displayed and the operation or utilization of its various functions may be provided by functional pushes or other command strings embedded into a programming signal, an URI, an EFM, or otherwise. Thus, the control layer 704 provides the functionality needed to call an EFM for presentation within or upon the Movie Player 600 and also to control the presentation of the Flash Movie and/or the EFM.

The Movie Player 600 also preferably includes a Diagnostic/Scripting layer 712. This layer 712 is commonly hidden from view of a client and provides a listing of triggers and other functional information that the Movie Player 600 may need in order to determine when during the presentation of a Flash Movie to activate a trigger and fetch Enhanced Content related to a given frame of the Flash Movie. This layer 712 may also be utilized during the encoding of an EFM to troubleshoot and debug an EFM.

The software code utilized to create the Movie Player 600 may be accomplished in JavaScript, EcmaScript, ActionScript or a derivation thereof (which are hereinafter collectively referred to as “JavaScript”). However, those skilled in the art appreciate that other programming languages may be utilized, as desired, to provide the functionalities of the Movie Player. The JavaScript code utilized by at least one embodiment of the present invention to create the Movie Player 600 is provided in Appendix A. Attached on one compact disc is a computer program listing appendix (“Appendix A.txt”). As discussed above, this JavaScript program, or a program with similar functionalities, is included at the beginning of each EFM so that the Flash plug-in on each client's Web browser is suitably configured to present an EFM.

Referring again to FIG. 6, the present invention suitably utilizes numerous layers to provide Enhanced Content in conjunction with a Temporal Signal that has been encoded into a Flash Movie. In providing such capabilities, the system creates distinctions between the Flash Movie layer 602 and the other layers (i.e., the Movie Player 600 and the Enhanced Content layer 604). By utilizing such distinctions, the system can overlay, as desired, the various layers such that certain elements may be visible at any given time to the client. For example, during the start-up of an EFM, the Movie Player 600 may be presented to the client. However, once the Flash Movie begins, it is generally undesirable to present the control and timing functions provided by the Movie Player 600 and, hence, the Movie Player 600 is suitably hidden in the background. Similarly, when a client provides a command to pause, stop, fast forward, or similarly control the presentation of a Flash Movie, via a user interface, the system is configured to suitably present the control layer 704 and/or other layers in a given orientation on the presentation device as predetermined by the EFM and/or the client. Thus, it is to be appreciated that the various layers may be visible (or even audible) or hidden at any given time as specified by user preferences, producer preferences, the stage of the presentation of the EFM, or any other variable.

Further, separating the presentation into the various layers enables the Flash Movie to be presented on the Flash Movie layer 602 in the same manner as any other Flash Movie is presented. As such, unique software codes or routines are not needed to present a Flash Movie provided with or without an EFM. Additionally, it is commonly appreciated that a layer may be configured to fit within in a window on a given display. The present invention supports such functionality utilizing commonly known in the art window manipulation techniques. Thus, the Flash Movie layer 602 may overlay the other layers, be included within a window on such other layers or be otherwise presented to the client.

Referring again to FIG. 6, additional layers which may be presented to a client via a Web browser before, during, or after a presentation of an EFM include the Enhanced Content/Chat/Advertisement layer 604. As discussed previously, these layer(s) 604 may be overlaid or included within other layers. Further, a distinct layer may be configured for each type of content (i.e., a separate Enhanced Content layer, a separate Chat layer, and a separate Advertisement layer may be provided).

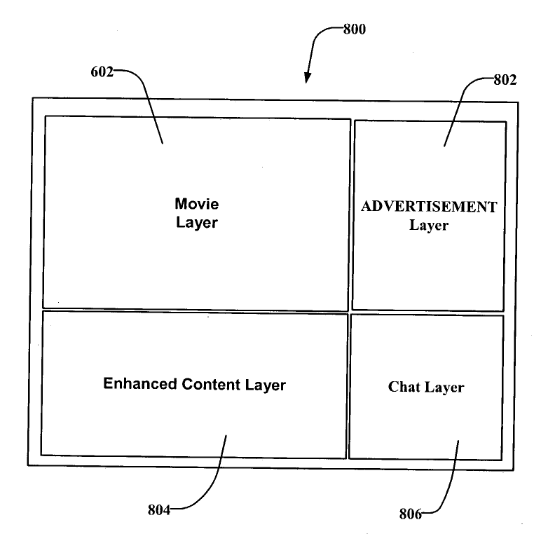

As shown in FIG. 8, these various layers may be presented on a single presentation device using multiple windows. For example, the Movie layer 602 may be presented on a frame/layer/window on the display area 800, while an advertisement layer 802, an Enhanced Content layer 804, and a Chat layer 806 are presented in other frames/layers/windows on the display area 800.

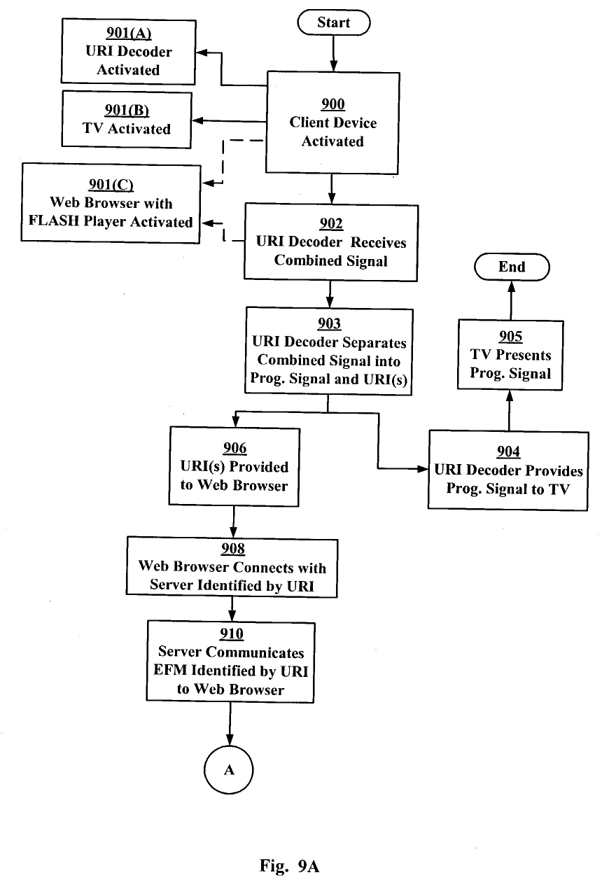

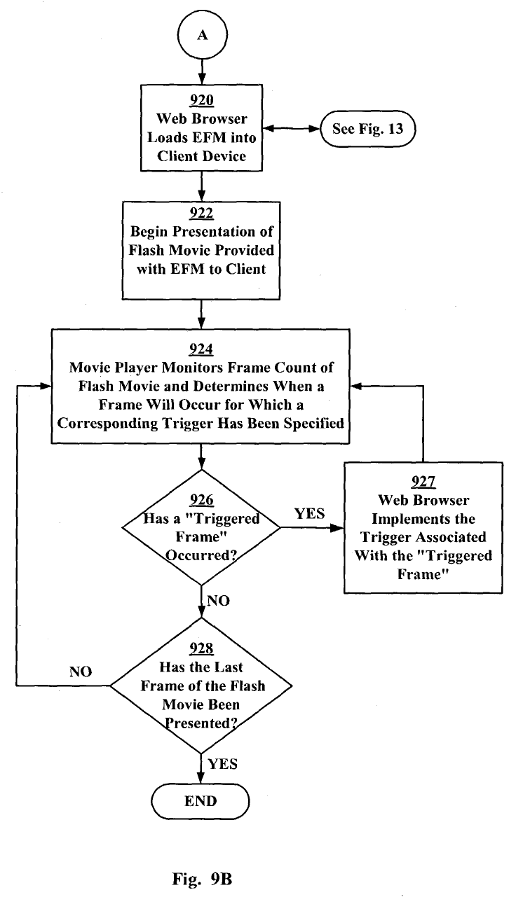

Referring now to FIGS. 9A-9B, a flow chart is provided which illustrates a first method consistent with the present invention by which a client device, and specifically a Web browser, in a system 100 (as shown in FIG. 1), retrieves an URI identifying an EFM from a combined programming signal, obtains the EFM from a server, presents a Temporal Signal contained within a Flash Movie portion of the EFM, and presents Enhanced Content that is identified by triggers provided in the EFM, wherein the Enhanced Content relates to and is synchronized to the content of the Flash Movie. More specifically, in operation 900, a user activates the client device. In this embodiment, the client device, automatically or upon user command, activates an URI decoder and a TV (or other presentation device), as provided for in operations 901A and 901B. Further, the client or client device may also activate a Web browser which includes a Flash player, as shown in operation 901C. Alternatively, the Web browser may be automatically activated when the URI Decoder receives a combined signal, as provided for in operation 902. Thus, it is to be appreciated that the client device may be configured to automatically or upon user command activate an URI decoder, a TV or other presentation device, and/or a Web Browser in order to provide Enhanced Content which relates to a Flash Movie and which corresponds to a programming signal.

Upon activation of the URI decoder, the TV and/or the Web browser, the method continues, in operation 902, when the URI decoder receives a combined signal. As discussed previously, the combined signal may be provided via any communications medium and in any format. The URI decoder, which may include or utilize other commonly known in the art units (such as, receivers, pre-amplifiers, filters, demodulators, decoders and the like), is suitably configured to receive and process such combined signals.

In operation 903, upon receiving a combined signal, the URI Decoder performs the following operations. The URI decoder separates the combined signal into the address/URI component and the programming signal component. Further, it provides the programming signal to the TV, as shown in operation 904, whereupon receiving the programming signal, the TV suitably presents the signal to the client (operation 905) until the programming signal is terminated or the TV is turned-off. Additionally, in operation 906, the URI Decoder provides the URI(s) extracted from the combined signal to the Web browser. These operations 904-906 may be performed in any reasonably possible order.

When an URI identifying an EFM is received in a combined signal and the programming signal component and the URI component are extracted by the URI decoder, the programming signal may be changed to another channel or programming signal without interfering with the utilization of the URI(s) referencing an EFM, the presentation of a Flash Movie contained in the EFM, or the presentation of Enhanced Content related to the EFM. Further, depending upon capabilities of any given system (such as, the number of or level of redundancy in the receivers, presentation devices, processors and other components being utilized) the method may be modified to allow for multiple programming signals to be presented, for programming signals to be changed at any time to another signal (i.e., channel surfing), for multiple EFM or Flash Movies to be presented and even for multiple instances of Enhanced Content or other functionalities to be presented. As such, the systems and methods of the present invention are not limited to a single presentation device for a single programming signal, or a single Web browser for a single EFM, or any other such configuration limitations.

Also, the method of FIGS. 9A-9B, provide for the URI(s) to be presented with the programming signals. Alternatively, the URI(s) may be sent independently of the programming signal from a server to which the client device establishes a connection (either automatically or upon user command). The delivery of the URI(s) for the EFM(s) which relate to the programming signal is a means for synchronizing a Temporal Signal, such as the programming signal, with other temporal signals and/or Enhanced Content that can be presented in a Flash environment and synchronized via triggers provided within an EFM.

Referring again to FIG. 9A, in operation 908, upon receiving an URI from the URI Decoder, the Web browser establishes a connection with a server identified by the URI. The server may be accessed via a network location or a dial-up connection. As discussed previously, a combined signal may include URIs which provide an address for a specific segment of Enhanced Content and/or URIs which provide an address for an EFM. As used in the context of the method shown in FIGS. 9A-9B, the URIs of interest are those that provide an address for an EFM and not those that merely provide an address for a segment of Enhanced Content.

Upon receiving the URI from the Web browser, in operation 910, the server suitably communicates an EFM to the Web browser. The EFM provides a Flash Movie which relates to the programming signal being presented via the TV or other presentation device. However, it is also quite possible to provide an URI which references an EFM that does not relate to the content of the programming signal. For example, during a broadcast of a football game an URI might be provided which addresses an EFM relating to a breaking news or sporting event, which may not directly or indirectly relate to the contents of the programming signal.

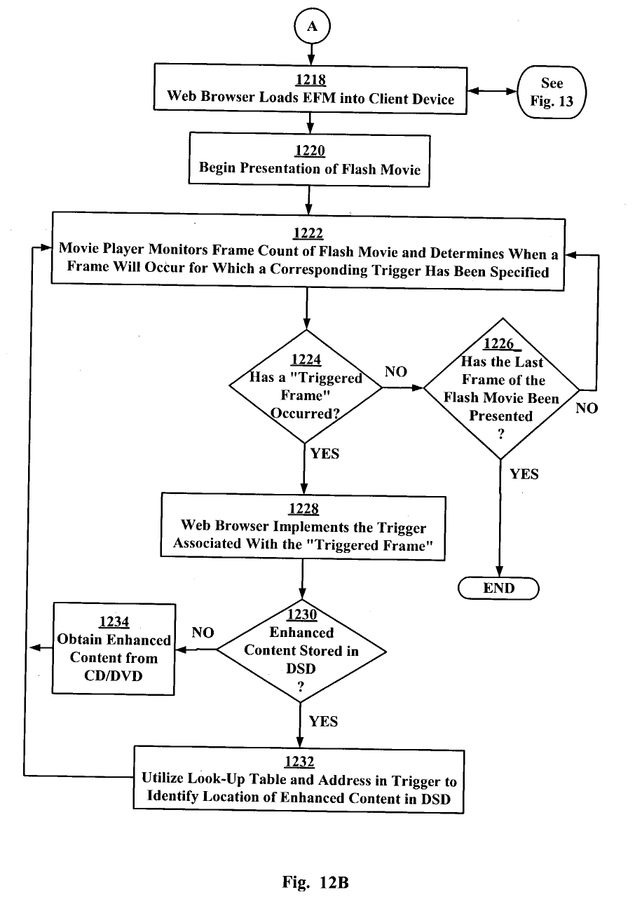

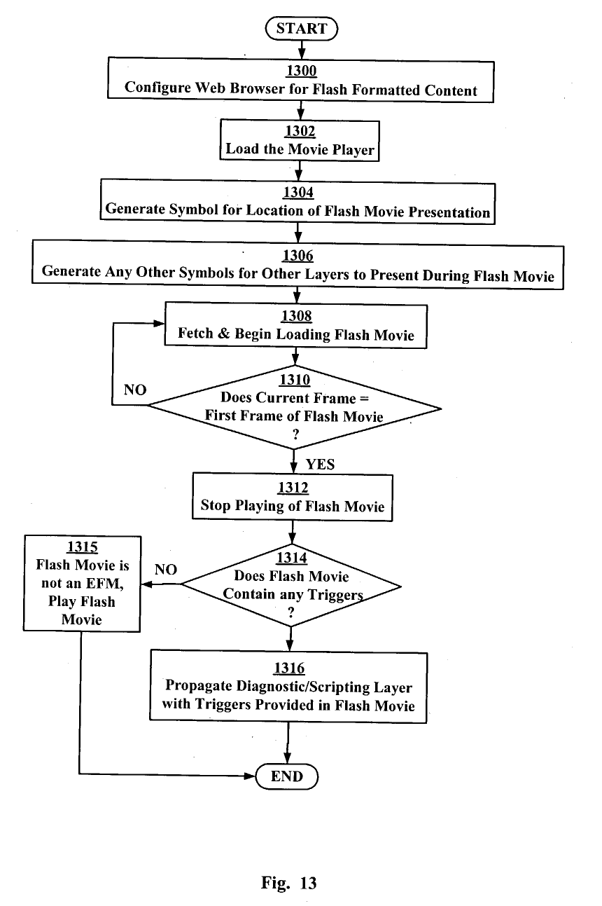

Continuing with operation 920 in FIG. 9B, upon receiving an EFM from the server, the Web browser loads the EFM into the client device. The process by which the Web browser loads the EFM is discussed in greater detail hereinbelow and with reference to FIG. 13.

Once the EFM has been loaded into the client device, the method continues in operation 922 with beginning the presentation of the Flash Movie, provided with the EFM, to the client. As discussed previously hereinabove, the EFM includes at least three components: a Movie Player component, which enable the client device to control the presentation of a Flash Movie, to monitor the frame count of the Flash Movie and to determine when to activate a trigger; a Flash Movie component which provides a Temporal Signal in the Flash format; and at least one trigger which identifies Enhanced Content to provide to the client when a specific frame of the Flash Movie component is being presented on the Web browser. As used herein, the Flash Movie relates to the content of the programming signal and provides “core functionalities” for such programming signal. For example, a Flash Movie may provide additional graphics and segments which relate to an occurrence happening in a broadcast of a football game. Such graphics and segments may include, for example, touchdown graphics and text corresponding to key players on the team. The triggers provided in an EFM identify segments of Enhanced Content which provide “non-core functionalities” that are to be retrieved and presented when specific frames of the Flash Movie are presented. Such non-core functionalities may include a sudden death overtime graphic, or a specific graphic about a player who just scored (for example, the touchdown was the player's 3^{rd} in a game) or a graphic about next week's game or similar functionalities that may be difficult or inefficient to provide in the Flash Movie or may be dynamically provided. However, it is to be appreciated that any or all of the programming signal, the Flash Movie, and Enhanced Content segments (which may be “triggered” and relate to the Flash Movie or “non-triggered” and relate to the programming signal) may provide, at any time, “core functionalities” and/or “non-core functionalities.” In operations 924-928, as the Flash Movie is being presented, the Movie Player monitors the frame count and determines when to activate any triggers that have been provided in the EFM. More specifically, in operation 924, the Movie Player monitors the frame count of the Flash Movie. In operation 926, the Movie Player detects when a “triggered frame” (i.e., a frame of the Flash Movie for which a trigger has been specified in the EFM) occurs by repeatedly querying the Timer/Frame Counter Layer (as discussed previously herein with reference to FIG. 7) as to the current frame being presented in the Flash Movie. When a “triggered frame” occurs, in operation 927, the Web browser, via the Movie Player application, implements the trigger associated with the “triggered frame.”

Referring again to operation 926, when the current frame is not a triggered frame, the method proceeds to operation 928 and the Movie Player determines whether the last frame of the Flash Movie has been presented. If the last frame has been presented, the method ends. If the last frame has not been reached, the method continues, in operation 924, with the Movie Player continuing to monitor the frame count and implementing triggers when a “triggered frame” occurs. This loop in operations 924-928 continues until the last frame of the Flash Movie is reached or the Flash Movie is otherwise interrupted or terminated.

In certain embodiments, a trigger or segment of ActionScript™, JavaScript™ code external to the Movie or other coding may be provided at the end of the Flash Movie which effectively restarts the Flash Movie and “reloads” the triggers. Such an embodiment, for example, might be desirable when a producer desires to cycle through a given series of commercials during a broadcast of a football game or a similar event. The commercials may be provided in the Flash Movie while the triggers may provide addresses to Enhanced Content that may be created real-time and may be more closely related to action in the football game.

Further, it is to be appreciated that when implementing a trigger, in operation 927, the Movie Player may be configured such that a trigger associated with a frame is activated upon the occurrence of the frame, a certain number of frames before a specified frame occurs (in order, for example, to retrieve the specified Enhanced Content from a remote server in advance of the desired presentation time of the Enhanced Content), or even a certain number of frames after a triggered frame occurs. It is to be appreciated that each trigger may be uniquely configured as to when an address associated with the trigger is utilized to retrieve Enhanced Content.

Further, it is generally appreciated that a Flash Movie is often configured as a stand-alone presentation, which may be controlled by a producer or controlled by a server-side playlist, script, application, or other functionality on a server. An EFM may also be similarly configured. More specifically, an EFM may be controlled directly by a server providing redirects to the URI(s) contained in the triggers. For example, upon receiving an URI specified by a trigger in an EFM, the server/Enhanced Content provider associated with the trigger may be configured to redirect the client's Web browser to another URI or address identifying a source of Enhanced Content. This may be accomplished by having a simple redirect associated with the URI provided with the trigger, or by providing at the server an application program (such as, a profiling program, JavaScript, and/or other application) which is identified by the trigger's address component and implemented upon the Web browser establishing a connection with the server identified by the address provided with the trigger.

Similarly, Macromedia ActionScript™ is an object-oriented scripting language that allows a developer to define a set of instructions that run when a triggering event occurs. This functionality enables the EFM to provide scripts that are triggered when a specific frame of a Flash Movie provided with the EFM occurs. Such scripts may be located local or remote to the Web browser and, may even be downloaded prior to, during or after the presentation of the Flash Movie or a specific frame of a Flash Movie. The Flash Movie could also subscribe to external timing services and receive notification when times with triggers occur. The Flash Movie may be configured to subscribe to an external time and trigger mechanism where the needs of executing triggers may be event-based. For example, the EFM may be configured to subscribe to an event service and when an external system wants to send Flash a message (e.g., that a trigger has been triggered and the EFM needs to perform some task) it connects to the EFM and communicates the message. The trigger may be kept in a Virtual Stage or on a Flash server and when each trigger is activated, an event (such as a “gotoframe”) is provided to the Flash Movie.

The triggers provided in an EFM might include functionalities that involve user interactions. For example, a button or even a series of buttons may be presented on the screen of the Web browser during a specific frame of the Flash Movie, whereupon “clicking” upon any given button (with a mouse or similar user control device) an URI is utilized to fetch a specific segment of Enhanced Content. Similarly, the system may be configured such that “clicking” upon a different button will result in a different URI being utilized to fetch a different segment of Enhanced Content.

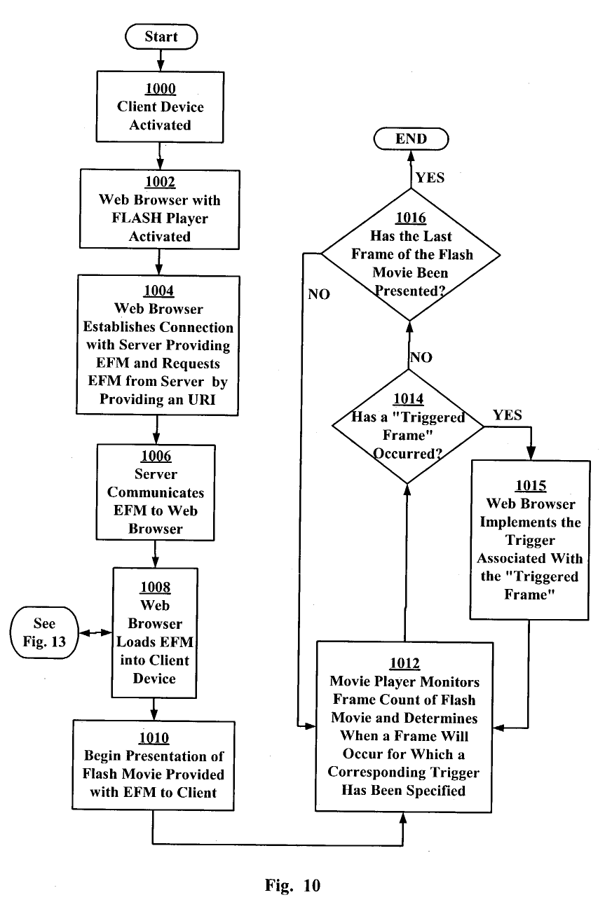

It is to be appreciated, that in the system embodiments shown in FIGS. 1 and 2 and the method shown in FIGS. 9A-9B, the EFM and the presentation of Enhanced Content related thereto is synchronized to the presentation of a programming signal. As mentioned previously, other Enhanced Content (i.e., Enhanced Content that is not provided in relation to an EFM) may also be identified in the combined signal and presented in conjunction with, or separate from, the Flash Movie and/or the Enhanced Content related to any given EFM. Further, the EFM may also be provided separate from a programming signal, as discussed previously with respect to FIG. 3. A method, consistent with the present invention, for receiving Enhanced Content in a stand-alone EFM embodiment is illustrated in FIGS. 10A-10B.

As shown in FIG. 10, this method begins, in operation 1000, with the client device being activated. Since this method is being provided with relation to FIG. 3, it is to be appreciated that for this embodiment only a single client device needs to be activated. Examples of such a client device include a computer workstation, a Personal Data Assistant (PDA), a hand-held computer, a suitably equipped wireless devices (such as a wireless telephone/PDA), an Internet equipped television or any other device which is capable of presenting a Flash Movie and Enhanced Content.

In operation 1002, a Web browser with a Flash Player is activated. Commonly, a client must first turn-on a client device, such as a personal computer, prior to activating a Web browser. As such, FIG. 10 illustrates such steps as occurring sequentially. However, those skilled in the art appreciate that the activation of a Web browser may be included in the start-up or initialization routines of a client device. Further, this method provides for the activation of a Web browser, in order to provide a platform upon which a Flash Movie may be presented. This operation too may not be needed for certain devices in which a Flash Movie may be presented without utilizing a Web browser.

Once the client device is suitably configured to present a Flash Movie, the method continues in operation 1004 with the Web browser establishing a connection with the server providing the EFM. Upon establishing the connection between the server and the client device/Web browser, the Web browser provides an URI which identifies a specific EFM and requests the server to provide the desired EFM. In response to receiving the request for the EFM, in operation 1006, the server communicates the EFM to the Web browser/client device.

Referring again to FIG. 10, in operation 1008, the Web browser loads the EFM into a client device. One method of loading an EFM into the client device is shown in FIG. 13 and is described in greater detail hereinbelow.

Once the EFM is loaded into the client device, the method continues in operation 1010 with beginning the presentation of the Flash Movie, monitoring the frame count for “triggered frames” (in operation 1012), implementing triggers when a “triggered frame” occurs (in operations 1014-1015), and continuing to monitor the frame count and/or implement triggers until the last frame of the Flash Movie is encountered (in operation 1016). As such, once the EFM is obtained from the server and loaded into the client device, operations 1010-1016 are performed. These operations are preferably identical to those performed in operations 922-928 of FIG. 9B. As discussed previously, the Enhanced Content which is triggered by an EFM may be obtained either directly or indirectly from the server providing the EFM and/or from other Enhanced Content providers. FIGS. 1-3, and 9-10 do not illustrate such various configurations or operations, but, those skilled in the art will readily appreciate the numerous devices, connections and sources by which Flash Movies and/or Enhanced Content related thereto can be provided to a client in conjunction with or separate from a programming signal.

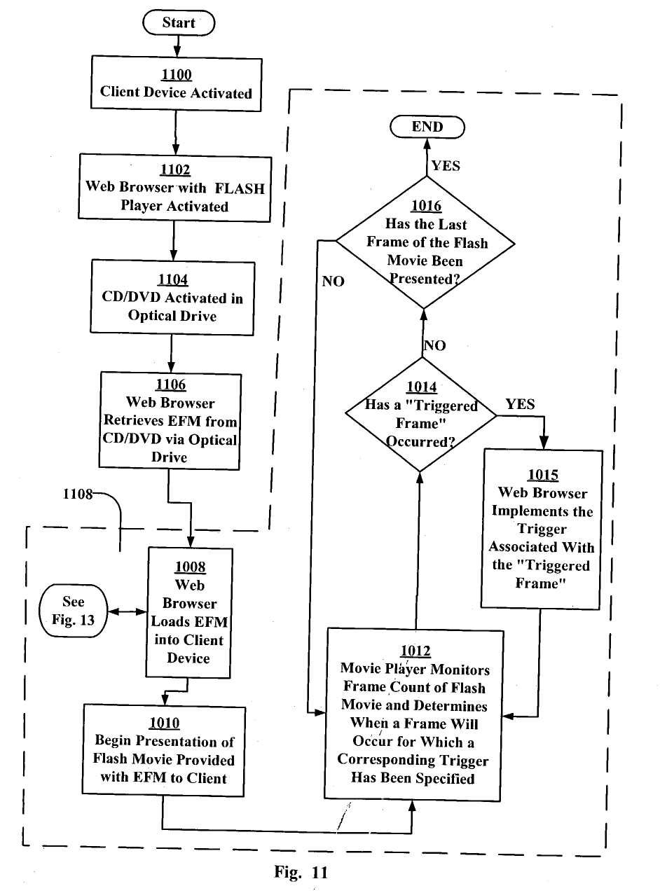

Referring now to FIG. 11, a method is illustrated for providing an EFM and Enhanced Content related to a Flash Movie provided in an EFM in conjunction with the system embodiment shown in FIG. 4. As shown in FIG. 11 and discussed previously, this embodiment utilizes a computer readable medium, such as, a CD or DVD, to provide the EFM and the Flash Movie. The Enhanced Content related to the Flash Movie and identified by triggers provided in the EFM is provided via a network connection with an Enhanced Content provider.

This method begins in operation 1100 with activating the client device. Once the client device is activated, in operation 1102, the Web browser with a Flash player is activated. These operations (1100 and 1102) may be accomplished as provided for above with reference to FIGS. 9A-9B, FIG. 10, or otherwise. At this point in the method, the client device is configured to identify, retrieve and present an EFM. However, in this embodiment, instead of obtaining the EFM from a server over a suitable communications link, the EFM is provided on a CD/DVD and retrieved from such computer readable medium by a local (or, in certain embodiments, a remote) optical drive. As discussed above, the CD/DVD are being used herein as illustrative of a computer readable medium which may store an EFM. Similarly, the optical drive is representative of a device capable of obtaining the EFM from such computer readable medium. It is to be appreciated that other mediums and/or devices may be utilized as desired.

In operation 1104, the CD/DVD containing the EFM is activated in the optical drive. As is commonly known in the art, a CD/DVD or other medium may contain megabytes and even gigabytes of data. As such, it is anticipated that a single CD/DVD may contain many EFMs and/or other content which is suitably identified on the disc in a directory or other listing and retrieved therefrom using known in the art systems and processes. Once the optical drive is activated, the method continues in operation 1106 with the client device retrieving the EFM from the CD/DVD. Operation 1106 may be accomplished automatically or upon client command.

At this point, the method continues as provided for with reference to FIG. 10, operations 1008-1016, which collectively are identified in FIG. 11 as operation 1108. As such, in operation 1108, the method provides for presenting a Flash Movie provided with the EFM (the Flash Movie may be a segment of the EFM or may be provided on another sector on the CD/DVD), monitoring the frame count and retrieving the identified Enhanced Content over a network connection (such as the Internet), when the corresponding triggered frame occurs in the Flash Movie.

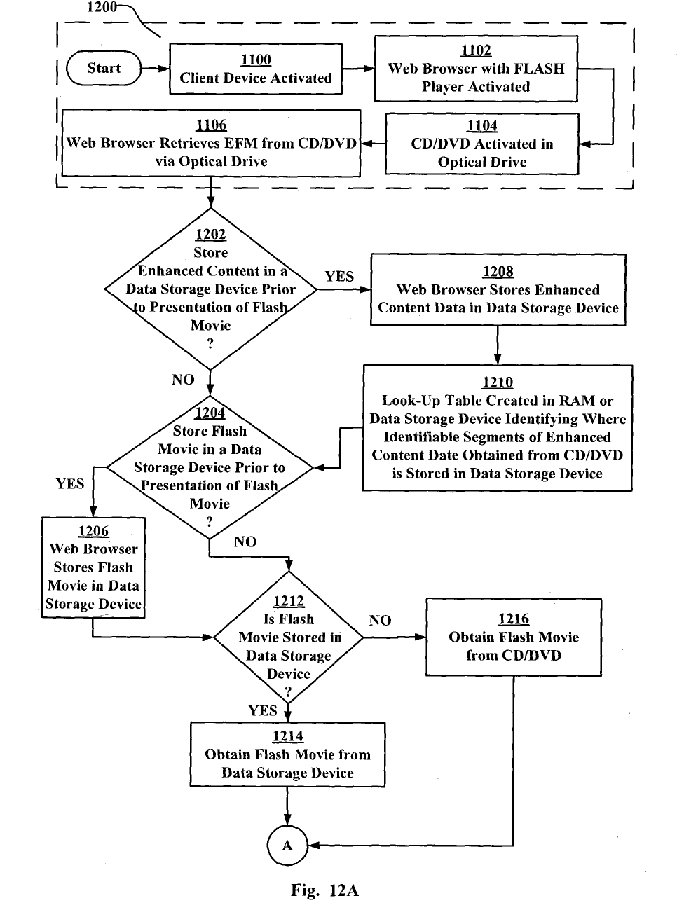

In FIG. 12A-B, with reference to FIG. 5, another embodiment of a method for identifying, retrieving and presenting an EFM is provided. In this embodiment, the EFM (including the Flash Movie, the Movie Player and the triggers) and the Enhanced Content identified by the trigger(s) are provided on a CD/DVD (or combination thereof). However, the EFM and/or the Enhanced Content may be suitably downloaded prior to the beginning of the Flash Movie. In this embodiment, a connection with a server is not utilized to identify, retrieve and present an EFM. It is anticipated that such an embodiment might be popular in mobile devices or in instances where a connection to a network is not practical or feasible. As shown in FIG. 12, an initialization routine 1200 may be implemented. This routine 1200 is similar to operations 1100-1106 previously discussed with respect to the method shown in FIG. 11. In short, and as discussed above with reference to FIG. 11, during the initialization routine 1200, essentially, the client device, a Web browser and an optical drive are activated and an EFM is obtained from the optical drive.

Upon completion of the initialization routine 1200, the method proceeds in operation 1202 with determining whether the Enhanced Content provided on the CD/DVD is to be stored on a data storage device prior to presentation of the Flash Movie. In implementing this operation, the client device may take into consideration various factors, such as, the amount of Enhanced Content to be retrieved from the CD/DVD, whether the Enhanced Content is provided on the CD/DVD in a format that requires decompression or other processing prior to its utilization, whether the processor or similar component on the client device is capable of providing a Flash Movie while it also obtains Enhanced Content from the CD/DVD, and various other factors. Alternatively, this operation may also be accomplished by following predetermined procedures such as a particular client device may be configured to always copy the Enhanced Content. Further, it is to be appreciated that various tables and other data structures may be provided on certain tracks of the CD/DVD that assist the client device in determining in what format the Enhanced Content is being provided, in what format the Enhanced Content may need to be converted into in order to present it to the client, the amount of data contained in any given segment of Enhanced Content, and other information which may be helpful in determining whether to store the Enhanced Content in the data storage device.

When it is desirable/necessary to first save the Enhanced Content in a data storage device, the method continues in operation 1208 with copying the Enhanced Content from the CD/DVD and suitably saving such content in the designated data storage device(s). Since each client device will most likely utilize these memory locations which are available and convenient, the method continues in operation 1210 with creating a look-up table which provides a correlation between the address/identifier utilized on the CD/DVD to designate a given segment of Enhanced Content and the address of the memory location at which such Enhanced Content has been stored. As discussed previously, such look-up table may be utilized by the Web browser to redirect the Web browser from the address provided in the predetermined trigger to the actual location in the data storage device of the saved Enhanced Content. The look-up table may be stored in RAM, in the data storage device, in registers, or at any other location from which it may be readily accessed by the Web browser.

Further, it is to be appreciated that in certain embodiments, specific memory locations may be reserved for storing Enhanced Content and that such memory locations may be specified by the triggers. In such an embodiment, operation 1210 may not be needed as the look-up table/redirecting process may not be needed in order to identify and retrieve a given segment of Enhanced Content that has been stored in a data storage device.

Regardless of whether the Enhanced Content is saved or is not saved, the method continues in operation 1204 with determining whether the Flash Movie, provided in the EFM, is to be stored in a data storage device prior to presentation of the Flash Movie. This query is provided because in certain embodiments it may be necessary to first extract, decompress, and/or otherwise manipulate a Flash Movie prior to presentation. When such additional processes are required, certain client devices may not have the necessary system speed to process the Flash Movie real-time such that a smooth and non-jerky presentation is provided. Thus, it may be desirable to first extract, decompress and save the otherwise processed Flash Movie such that the actual presentation is not interrupted by downloads and other processing. As shown, the method provides for such Flash Movie processing and saving in operation 1206, wherein the Web browser suitably stores the Flash Movie in the data storage device.

At this point, the client device is configured to present the EFM. Those skilled in the art will readily appreciate that the foregoing operations may generally be accomplished by certain higher processing speed systems, (for example, systems using a Pentium III™ or Pentium IV™), in milliseconds or even a few seconds, such that any user perceptible delay which may occur, if any, is minimal. As shown in FIG. 12B, the method continues in operation 1212 with the Web browser determining from where the Flash Movie that is to be played, is to be retrieved (i.e., is the Flash Movie stored in the data storage device). While operation 1212 is shown to occur after operation 1204, it is to be appreciated that such operation may occur at a later time and need not be proximate in time to those operations preceding it.

More specifically, the method continues in operation 1212 with determining from where the Flash Movie is to be retrieved. If the Flash Movie was previously saved in the data storage device, the method continues in operation 1214 with obtaining the Flash Movie from such data storage device. It is to be appreciated, for large Flash Movie files, that this operation may require repeated extractions of segments of the Flash Movie from the data storage device; as buffer space provided in a given client device may limit the quantity or size of Flash Movie segments that can be utilized at any given time. Procedures for extracting large files from data storage devices during the presentation of a Flash Movie are well known in the art; any such procedures may be utilized in conjunction with the present invention.

Referring again to operation 1214, when the Flash Movie was not earlier stored in the data storage device, the method continues in operation 1216 with obtaining the Flash Movie from the CD/DVD. It is to be appreciated that such operations may utilize the data storage device and other client device components in obtaining and/or presenting the Flash Movie.

After obtaining the Flash Movie (which as discussed later, with reference to FIG. 13, is utilized in the loading of the EFM process), the method continues in operation 1218 with loading the EFM into the client device. As discussed previously, this operation is generally described with reference to FIG. 13. But, it should be appreciated that the functionalities provided by the Movie player or other components of an EFM may be provided on the CD/DVD, provided as a part of the Flash Movie, provided in a separate data file, or even built into the Flash player, the Web browser, and/or the client device. When the Movie Player and similar components are provided separately, or are built into the Flash player, the Web browser and/or the client device, the actions performed in operation 1218 may be limited to merely retrieving the triggers provided in the EFM. It is anticipated that this will be the preferred embodiment, since space on a CD/DVD will not be needed for providing the Movie Player and/or the Flash plug-in.

Upon loading the EFM into the client device/Web browser, the method continues in operation 1220 with presenting the Flash Movie. Preferably, this operation is performed under the control or direction of the Movie Player such that synchronization of the Flash Movie with the frame counter is obtained. As provided for in operation 1222, the Movie Player continually monitors the frame count of the Flash Movie, determining when a “triggered frame” has/will occur. This monitoring process is illustrated in operation 1224. As shown, when a triggered frame does not occur, the method continues in operation 1226 with determining whether the last frame of the Flash Movie has occurred. If so, the method ends. If not, then the method continues to proceed through operations 1222-1224 until either the last frame occurs or a “triggered frame” occurs.

As shown in operation 1228, when a “triggered frame” occurs, the method continues with the Movie Player/Web browser implementing the trigger. In operation 1230, the Movie Player/Web browser determines whether the Enhanced Content identified by the trigger has been stored in the Data Storage Device (DSD) or is to be retrieved directly from the CD/DVD. If the Enhanced Content is stored in the DSD, in operation 1232, the Movie Player, the Web browser or the client device suitably utilizes the look-up table, as necessary, to identify and provide the Enhanced Content to the client. Alternatively, if the Enhanced Content is not stored in the DSD, the method continues in operation 1232 with obtaining the Enhanced Content directly from the CD/DVD, which may be accomplished using known in the art methods.

Referring now to FIGS. 13A-13B and as mentioned previously, one embodiment of a method by which the Web browser loads an EFM into the client device is provided. As shown in operation 1300, this method begins with activating a Flash™ plug-in, such that the Web browser, or at least one window in the Web browser (as desired by specific clients and/or applications) is configured to receive and present Flash™ formatted content. The operations utilized to configure a Web browser for Flash™ files are well known in the art and are not discussed in detail herein.

Upon configuring the Web browser for Flash™ formatted content, the method continues in operation 1302 with loading the Movie Player. As discussed previously, the Movie Player is preferably a Flash Movie that includes the functionality of providing a timer/frame counter layer, a control layer, and a diagnostic layer. More specifically, the Movie Player operates as a place holder for the additional functionality of playing the Flash Movie, monitoring the frame count and utilizing the triggers. When the Movie Player is activated, a symbol, the “movie holder symbol” is created which functions as a place holder for a window in which the Flash Movie will be presented, as shown in operation 1304. As shown in FIG. 8, this window is preferably created in the upper left corner of the Web browser's display, however, it may be positioned anywhere within the Web browser's viewable area and may be expanded and contracted using commonly known window manipulation techniques. Associated with this place holder are also various variables providing information as to the size of the window, the resolution and other information pertinent to generating the window. The Movie Player may also create other symbols which act as place holders for other layers, such as, the Enhanced Content Layer, the Advertisement Layer and/or the Chat Layer as previously described with reference to FIG. 8). The place holders that are to be created for the EFM are preferably specified in advance by the Movie Player coding provided with the EFM. Further, it is to be appreciated that these place holders may be configured, added, deleted, modified or otherwise manipulated by clients as desired. For example, a client who does not wish to receive chat messages may simply delete the place holder prior to, during, after a Flash Movie presentation. Some layers, however, such as the Advertisement Layer, may not be client configurable or may provide limited client control of their features, placement and/or operation.

Once the various place holders have been created, the method continues in operation 1308 with the Movie Player Fetching the Flash Movie. As discussed previously, the Flash Movie or the initial segments of the Flash Movie have already been obtained from the data storage device and/or the CD/DVD. As such, this fetch operation may be accomplished with little if any delay. More specifically, this operation may be initiated automatically or by user action, for example, the user may depress or “click upon” a “Fetch” button provided in a control layer (such as the control layer illustrated in FIG. 7).

When the operation of fetching the Flash Movie is initiated, the Movie Player, proceeds with operations 1308-1310 and directs the video or audio segments (or if the Flash Movie is only an audio file) to begin playing. Often a Flash Movie (regardless of whether in a video, audio or other format) contains various preliminary signals which are followed by the first frame of the actual presentation. The Movie Player, in the fetch operations 1308-1310, suitably loads the Flash Movie up to its first frame. At this time, the Flash Movie overwrites the movie holder symbol at it previously designated location and within the previously specified window. This operation may be carried out by using the commonly known Flash™ command “loadmovie (URL, movie holder)”, where the URL is the address identifying the location of the Flash Movie and the movie holder symbol designates to the Movie Player where the Flash Movie is to be presented.

Once the first frame of the Flash Movie is reached and before it is visible in the window specified by the movie holder symbol, in operation 1312, the Movie Player stops the playing of the Flash Movie and, in operation 1314, queries the Flash Movie as to whether any triggers have been provided with the Flash Movie. It is to be appreciated that in certain other embodiments, other frames of the Flash Movie may be designated as containing at least one trigger. In such an embodiment, the Movie Player provided and/or associated with the Flash Movie is appropriately configured to identify and utilize triggers positioned throughout the Flash Movie. If the Flash Movie does not contain any triggers, then the Flash Movie is not an EFM and the playing of the Flash Movie begins using commonly available Flash™ operations.

When the Flash Movie is an EFM and triggers are provided, in operation 1314, the Movie Player will suitably detect the presence of the triggers in the Flash Movie. These triggers are preferably provided in the root level memory space of the Flash Movie as a series of symbols (e.g., trigger1, trigger 2). As discussed previously, these symbols/triggers provide a name value pair which designates a reference (for example, a frame) and an address from which Enhanced Content is to be obtained when the referenced frame in the Flash Movie is presented. Thus, in operation 1314, the Movie Player examines the root level memory for the presence of these symbols/triggers. In operation 1316, those triggers that are provided in the Flash Movie and detected by the Movie Player are propagated into the Diagnostic/Scripting layer (as discussed previously with reference to FIG. 7). As discussed previously, the Diagnostic/Scripting layer is generally a hidden layer that is not presented to the client during the presentation of the EFM, however, it may be made visible (for example, for diagnostic purposes or when coding the EFM) by having the Movie Player generate a symbol at which the Diagnostic/Scripting layer is to be presented.

At this point of the method, the EFM has been loaded into the client device and the operations continue as provided for in the embodiments shown in FIGS. 9-12. Also, in an alternative embodiment, which is not shown, it may be possible to provide additional triggers separate from the Flash Movie. These additional triggers could be provided in the Movie Player itself and might be generic to all Flash Movies that are being presented by the Movie Player. Such a trigger might include a direction to display a logo for an advertiser every “x” number of frames in the Flash Movie or to perform other singular or repetitive tasks as specific frames in any given Flash Movie occur. As such, the present invention provides for various triggers to be utilized in conjunction with a Flash Movie. These triggers may be provided with the Flash Movie, or separately, but are preferably implemented based upon a predetermined relation to any given Flash Movie, such as a specific frame or the occurrence of an increment of frames. The JavaScript programs utilized to provide the before mentioned functionalities are attached hereto in Attachment A.

It is understood that there can exist alternative embodiments of systems and methods for use with the present invention. Although the present invention has been disclosed in conjunction with numerous embodiments, the scope of the present invention is not to be limited to one particular embodiment. Modifications may be made to the systems, method flows, techniques, devices utilized or any other element, factor, step, or the like without departing from the scope of the present invention as expressed in the preceding summary, detailed description and drawing figures and the following claims.

[image]

[image]

[image]

[image]

1. A system for presenting Enhanced Content related to a Flash Movie provided in an Enhanced Flash Movie (EFM) comprising:
a means for receiving an EFM, wherein the EFM includes at least one Flash Movie;
a Web browser, connected to the means for receiving an EFM, for presenting the Flash Movie, obtaining Enhanced Content related to the EFM and presenting the Enhanced Content.

2. The system of claim 1, wherein the means for receiving an EFM further comprises an URI decoder, whereupon receiving a combined signal containing a programming signal and at least one address identifying a provider of an EFM, the URI decoder obtains the at least one address from the combined signal and provides the address to the Web browser; whereupon receipt of the address, the Web browser obtains the EFM from a location identified by the address.

3. The system of claim 1, further comprising a presentation device, connected to the URI decoder, for presenting the programming signal.

4. The system of claim 2, wherein the presentation device further comprises at least one of an audio sound system, video system, television, computer monitor, headset, virtual reality system, tactile sensory system, home theater system, personal data assistant, set top box, and a gaming system.

5. The system of claim 1, wherein the means for receiving an EFM further comprises a communications link established between a provider of the EFM and the Web browser.

6. The system of claim 4, wherein the communications link further comprises at least one established via a connection over an Internet, intranet, extranet, serial network, parallel network, digital network, analog network, wireless link, wired link, or a combination of any of the preceding.

7. The system of claim 1, wherein the means for receiving an EFM further comprises at least one of a magnetic drive and an optical drive, and the EFM is provided on a data storage medium readable by at least one of the magnetic drive and the optical drive.

8. The system of claim 6, wherein the system further comprises a data storage device and at least one of the EFM and the Enhanced Content is retrieved, by the at least one of a magnetic and an optical drive, from the data storage medium and saved in the data storage device.

9. The system of claim 6, wherein the system further comprises a communications link for requesting and receiving Enhanced Content related to the Flash Movie from an Enhanced Content provider.

10. The system of claim 1, wherein the EFM further comprises at least one trigger, wherein the trigger includes a second address and an indication of when the second address is to be utilized; the second address identifying at least one provider of Enhanced Content that relates to the EFM.

11. The system of claim 9, wherein the at least one trigger is provided in the first frame of a Flash Movie, wherein the Flash Movie is provided with the EFM.

12. The system of claim 10, wherein the trigger is implemented by a Movie Player.

13. The system of claim 11, wherein the Movie Player further comprises:
a control layer, which enables a client, via the Web browser, to control the presentation of a Flash Movie provided with the EFM;
a timing and frame counting layer, in communication with the control layer, wherein the timing and frame counting layer receives an indication from the control layer when the Flash Movie is initiated and tracks the number of each frame being presented in a Flash Movie;
a scripting layer, in communication with the control layer and the timing and frame counting layer, which provides a repository for the trigger.

14. The system of claim 12, wherein the Movie Player further comprises a data structure that is provided with the EFM.

15. The system of claim 12, wherein the Movie Player further comprises a data structure that is built into the Web browser and wherein the EFM includes at least one trigger that is extracted by the Movie Player from the EFM and deposited into the scripting layer.

16. The system of claim 9, wherein the at least one trigger relates to a live Temporal Signal.

17. The system of claim 15, wherein the at least one trigger is executed based upon a command received from an external source.

18. The system of claim 16, wherein the external source further comprises a producer controlling the Flash Movie from a server.

19. The system of claim 9, wherein the at least one trigger includes a program code.

20. The system of claim 9, wherein the at least one trigger includes an event.

21. The system of claim 9, wherein the at least one trigger is executed based upon time.

22. The system of claim 9, wherein the at least one trigger is executed based upon a reference to a predetermined event.

23. A system for providing, to at least one client device, an EFM and Enhanced Content related to a Flash Movie provided with the EFM comprising:
a server for obtaining an EFM requested by at least one client device and providing the EFM to the at least one client device; and
at least one network connection, between the at least one client device and the server, facilitating the communication of the request and the providing of the EFM;
whereupon establishment of the at least one network connection between the server and the at least one client device and whereupon receipt by the server of the request, the server obtains and provides the requested EFM to the at least one client device.

24. The system of claim 22, wherein the system further comprises a data storage device, accessible by the server, for storing the EFM.

25. The system of claim 23,wherein the EFM is provided to the server and stored in the data storage device by and EFM Encoding System.

26. The system of claim 24, wherein the EFM Encoding System generates the EFM by inserting at least one trigger into the first frame of a Flash Movie.

27. The system of claim 26, wherein the trigger further comprises a mean value pair further comprising a variable and a value, wherein the variable identifies a trigger and the value segment further comprises a reference indicating when during the Flash Movie to utilize an address also provided in the value segment of the mean value pair.

28. The system of claim 26, wherein the address provided in the value segment of the mean value pair includes an URI identifying at least one provider of Enhanced Content.

29. A system for presenting Enhanced Content related to an EFM comprising:
a server which provides, to a client device, an EFM comprising a Flash Movie and at least one trigger;
an Enhanced Content provider which provides at least one segment of Enhanced Content related to the Flash Movie; and
at least one communications link between at least one of the Enhanced Content provider and the client device, the Enhanced Content provider and the server, and the server and the client device;
whereupon receiving the Flash Movie, the trigger and the EFM, the client device determines when, in relation to the presentation of the Flash Movie, to utilize an address provided with the trigger in order to retrieve the at least one segment of Enhanced Content related to the Flash Movie and present the at least one segment of Enhanced Content to the client device.

30. The system of claim 28, wherein the at least one communications link further comprises a communications link established utilizing at least one of the Internet, an intranet, a serial connection, an analog connection, a digital connection, a private network and a public network.
A system for providing an EFM to a client device comprising:
a means for providing a programming signal;
a means for encoding a programming signal into a Flash Movie;
a mean for providing at least one segment of Enhanced Content;
a means for combining the programming signal which has been encoded into a Flash Movie and at least one trigger into an Enhanced Flash Movie, wherein each of the at least one trigger includes an address identifying a provider of the at least one segment of Enhanced Content and an indication of when to utilize the address in relation to a presentation of the programming signal encoded into a Flash Movie; and
a means for providing the Enhanced Flash Movie to a client device.

31. The system of claim 30, wherein the means for encoding a programming signal into a Flash Movie utilizes an audio and/or video to Flash compiling software application.

32. The system of claim 30, wherein the means for providing the Enhanced Flash Movie to a client device further comprises a server.

33. A computer readable medium providing a data structure configured to present Enhanced Content related to a program encoded in Flash comprising:
a Flash Movie further comprising a Flash encoded programming signal;
a Flash Movie layer further comprising an application layer for presenting the Flash Movie;
at least one trigger providing an address and a reference to the Flash Movie, wherein the address identifies a provider of Enhanced Content and the reference identifies when, in relation to the presentation of the Flash Movie, the address is to be utilized to obtain from the provider at least one segment of Enhanced Content; and
a Movie Player layer, wherein the Movie Player layer controls the presentation of the Flash Movie, implements the at least one trigger and obtains the at least one segment of Enhanced Content identified by the at least one trigger.

34. The computer readable medium of claim 32, wherein the computer readable medium further comprises at least one of a compact disc, a digital versatile disc, a super audio compact disc, a magnetic tape, a floppy disc, a memory card, a flash card, a magnetically readable medium, and an optically readable medium.

35. The computer readable medium of claim 32, wherein the data structure is implemented via at least one Web browser.

36. The computer readable medium of claim 32, wherein at least one of the at least one segment of Enhanced Content and the Flash Movie is stored in a data storage device.

37. The computer readable medium of claim 35, wherein the data storage device is located local to a Web browser utilized by a client device to present the Flash Movie.

38. The computer readable medium of claim 35, wherein the data storage device is located remote to a Web browser utilized by a client device to present the Flash Movie.

39. An apparatus for presenting an Enhanced Flash Movie comprising:
a controller for controlling the presentation of the Flash Movie;
a timing and frame counter, in communication with the controller, for determining a current frame count of the Flash Movie as it is being presented; and
a script generator, which receives the current frame count from the timing and frame counter, provides a holding location for at least one trigger and implements at least one trigger when the current frame count equals a triggered frame number.

40. The Enhanced Flash Movie of claim 38, wherein the trigger further comprises a mean value pair further comprising a variable and a value.

41. The Enhanced Flash Movie of claim 39, wherein the value segment of the mean value pair further comprises an address and a reference to a certain frame of the Flash Movie as being a triggered frame, and the timing and frame counter counts each frame presented in the Flash Movie and utilizes the address provided in the trigger and associated with the triggered frame when the frame count determined by the timing and frame counter equals the reference frame specified in the trigger.

42. The Enhanced Flash Movie of claim 40, wherein the address of the mean value pair identifies a location from which at least one segment of Enhanced Content may be retrieved.

43. The Enhanced Flash Movie of claim 39, wherein the Enhanced Flash Movie is provided on at least one medium selected from the group consisting of a computer workstation, a personal data assistant, a Flash player, a television, a set top box, a home theater system, an audio system, a gaming system, and a video presentation system.

44. A computer readable medium providing a mean value pair data structure for specifying when, during the presentation of a Flash Movie, to utilize at least one address identifying a provider of at least one segment of Enhanced Content comprising:
a variable segment identifying a trigger;
a value segment, further comprising:
a reference, indicating when to utilize an address provided in the value segment of a mean value pair data structure; and
the address providing at least one identification of a provider of Enhanced Content;
whereupon the occurrence of a predetermined event specified by the reference, the at least one address provided in the value segment is utilized to contact the provider of Enhanced Content and provide the at least one segment of Enhanced Content to a client.

45. The computer readable medium of claim 43, wherein the mean value pair data structure is encoded into a Flash Movie as a trigger.

46. A program storage device readable by a machine, tangibly embodying a program of instructions executable by a machine to perform a method for providing Enhanced Content related to a Flash Movie during a presentation of the Flash Movie, the method comprising:
receiving an Enhanced Flash Movie further comprising a Flash Movie, a Movie Player and at least one trigger, wherein the at least one trigger further comprises a mean value pair data structure including a variable segment and a value segment;
establishing a Movie Player layer, wherein the Movie Player layer further comprises a control layer, a Flash Movie layer, a timing and frame counting layer and a scripting layer;
loading the Flash Movie into the Flash Movie layer;
identifying the at least one trigger provided in the Flash Movie and placing the at least one identified trigger into the scripting layer;
monitoring the frame count of the Flash Movie as the Flash Movie is presented; and
implementing the at least one trigger when a frame number specified in a reference provided in the value segment equals the current frame count;
whereupon implementing the trigger the Movie Player utilizes information provided in the value segment to identify a provider of Enhanced Content, establish a connection with the provider and obtain at least one segment of Enhanced Content from the provider.

47. A method in a computer system for providing Enhanced Content related to a Flash Movie, comprising:
providing an EFM comprising a Flash Movie and at least one trigger, wherein the trigger further comprises a variable segment and a value segment;
establishing a communications link between a client device and a provider of Enhanced Content identified in a value segment of at least one trigger, when a condition specified in a reference provided in the value segment is satisfied; and
providing at least one segment of Enhanced Content to the client device upon establishing of the communications link between the client device and the provider of Enhanced Content;
wherein the at least one segment of Enhanced Content provided is related to at least one frame of the Flash Movie provided with the EFM.

48. The method of claim 46, wherein the EFM further comprises a Movie Player.

49. The method of claim 47, wherein the Movie Player further comprises instructions for displaying, controlling and presenting the Flash Movie and the at least one segment of Enhanced Content related thereto, by:
generating, on a client device, a Movie Player layer; wherein the Movie Player layer further comprises:
a control layer;
a timing and frame counting layer, in communication with the control layer; and
a scripting layer, in communication with the control layer; and
generating, on a client device, a Flash Movie layer;
wherein the control layer enables a client to control at least one of the presentation of the Flash Movie and the at least one segment of Enhanced Content, the timing and frame counting layer determines when during the presentation of the Flash Movie to utilize a trigger and to retrieve the at least one segment of Enhanced Content, and the scripting layer provides a repository for the trigger.

50. The method of claim 48, wherein the Movie Player further comprises instructions for displaying, controlling and presenting at least one of an advertisement layer and a chat layer.

51. A process for providing Enhanced Content related to a Flash Movie provided in conjunction with a programming signal comprising:
(a) receiving a combined signal, wherein the combined signal further comprises a programming signal and at least one address identifying a provider of an EFM related to the programming signal;
(b) separating the at least one address from the combined signal;
(c) providing the programming signal to a presentation device for presentation to at least one client;
(d) providing the at least one address separated from the combined signal to a Web browser;
(e) establishing a connection between the Web browser and a server identified by the at least one address;
(f) receiving, from the server and at the Web browser, the EFM; wherein the EFM further comprises a Flash Movie, a Movie Player and at least one trigger, wherein the trigger further comprises a mean value pair data structure further comprising a variable segment specifying a trigger and a value segment providing a reference for when to utilize an address provided in the value segment and the address identifying at least one provider of Enhanced Content related to the Flash Movie;
(g) loading the EFM into the Web browser;
(h) presenting, with the Web browser, the Flash Movie;
(i) monitoring a frame count of the Flash Movie as it is presented;
(j) determining when a triggered frame will occur in the Flash Movie;
(k) implementing a trigger when a triggered frame occurs in the Flash Movie;
(l) repeating steps (h) to (k) until at least one of the Flash Movie ends and the presentation of the Flash Movie is terminated.

52. The process of claim 50, wherein the step of loading the EFM into the Web browser, further comprises:
configuring the Web browser for Flash formatted content;
loading a Movie Player;
generating a symbol designating a location on the Web browser for the Flash Movie to be presented;
fetching the Flash Movie from the EFM;
loading the Flash Movie into the Web browser at the symbol;
stopping the Flash Movie at a first frame of the Flash Movie;
determining whether the first frame contains any triggers; and
when the first frame does contain at least one trigger, propagating a scripting layer with each trigger.

53. The process of claim 50, wherein the step of implementing a trigger when a triggered frame occurs in the Flash Movie further comprises:
utilizing the address provided in the value segment to identify the at least one provider of Enhanced Content related to the Flash Movie;
establishing a connection with the provider at the at least one address;
obtaining at least one segment of Enhanced Content from the provider; and
presenting the at least one segment of Enhanced Content obtained from the provider to the client via the Web browser.

54. The process of claim 52, wherein the at least one segment of Enhanced Content obtained from the provider is presented to the client in an Enhanced Content layer provided on the Web browser.

55. A process for providing Enhanced Content related to a Flash Movie comprising:
(a) establishing a connection between the Web browser and a device providing an EFM;
(b) receiving from the device and at the Web browser, the EFM; wherein the EFM further comprises a Flash Movie, a Movie Player and at least one trigger, wherein the trigger further comprises a mean value pair data structure further comprising a variable segment specifying a trigger and a value segment further comprising a reference indicating when to utilize an address provided in the value segment, and the address providing at least one identification from where at least one segment of Enhanced Content related to the Flash Movie can be obtained by the Web browser;
(c) loading the EFM into the Web browser;
(d) presenting, with the Web browser, the Flash Movie;
(e) monitoring a frame count of the Flash Movie as it is presented;
(f) determining when a triggered frame will occur in the Flash Movie;
(g) implementing a trigger when a triggered frame occurs in the Flash Movie;
(h) repeating steps (d) to (g) until at least one of the Flash Movie ends and the presentation of the Flash Movie is terminated.

56. The process of claim 54, wherein the device providing an EFM further comprises a server.

57. The process of claim 54, wherein the device providing an EFM further comprises a computer readable medium, wherein the EFM is obtained from the computer readable medium via a device configured to access the computer readable medium.

58. The process of claim 56, wherein the device configured to access the computer readable medium further comprises at least one of an optical drive, when the computer readable medium further comprises at least one of a compact disc, a digital video disc, a super audio disc, and an optically readable medium, and a magnetic drive, when the computer readable medium further comprises at least one of a floppy disc, a hard disc, a memory card, a flash memory, and a magnetically readable medium.

59. The process of claim 54, wherein the device providing an EFM further comprises a data storage device.

60. The process of claim 54, wherein the device providing an EFM further comprises a data storage device.
